(19) United States
(12) Patent Application Publication
(10) Pub. No.: US 2026/0170224 A1
(43) Pub. Date: Jun. 18, 2026

(54) LAYOUT MODIFICATION METHOD AND METHOD OF MANUFACTURING INTEGRATED CIRCUIT DEVICE BY USING THE SAME

(71) Applicant: Samsung Electronics Co., Ltd., Suwon-si (KR)

(72) Inventors: Sanghwa Lee, Suwon-si (KR); Akio Misaka, Suwon-si (KR); Taekyum Kim, Suwon-si (KR); Bongkeun Kim, Suwon-si (KR)

(21) Appl. No.: 19/298,416

(22) Filed: Aug. 13, 2025

(30) Foreign Application Priority Data
Dec. 16, 2024 (KR) 10-2024-0187461

(51) Int. Cl. G06F 30/398; G03F 1/36; G06F 119/18

(52) U.S. Cl. CPC G06F 30/398; G03F 1/36; G06F 2119/18

(57) ABSTRACT

A layout modification method includes extracting first pitch regions each including first patterns from a layout, performing, through at least one loop process, a first modification to generate a first modified layout by shifting a position of at least one first pattern in each of the first pitch regions, after the first modification is performed, extracting second pitch regions each including second patterns from the first modified layout, classifying the second pitch regions into pitch region groups according to widths in a pitch direction of the second patterns, and performing a second modification to generate a second modified layout by shifting a position of at least one second pattern of each of the second pitch regions in descending order starting from a pitch region group having a maximum width in the pitch direction. To manufacture an integrated circuit device, the layout modification method is used.

### CROSS-REFERENCE TO RELATED APPLICATION

This application is based on and claims priority under 35 U.S.C. § 119 to Korean Patent Application No. 10-2024-0187461, filed on Dec. 16, 2024, in the Korean Intellectual Property Office, the disclosure of which is incorporated by reference herein in its entirety.

### BACKGROUND

The inventive concept relates to a layout modification method and a method of manufacturing an integrated circuit device, the method including the layout modification method, and more particularly, to a layout modification method for reducing stochastic defects generated in a pattern formation process that uses a photolithography process, and a method of manufacturing an integrated circuit device by using the layout modification method.

Lithography processes used in manufacturing processes of integrated circuit devices are processes of forming circuit patterns by irradiating light to photosensitive films coated on substrates. Recently, along with the reduction in line-widths of patterns formed on substrates, photolithography processes using extreme ultraviolet (EUV) have been used. In addition, as the sizes of patterns formed on substrates have been micronized, various techniques of modifying pattern layouts formed on photomasks have been proposed to reduce stochastic defects generated in pattern formation processes that use photolithography processes.

### SUMMARY

The inventive concept provides a layout modification method capable of reducing the area of a layout including a minimum-pitch pattern even without increasing the whole area of a designed chip in a mask data preparation (MDP) process for converting designed layout information into data required for photomask fabrication.

The inventive concept also provides a method of manufacturing an integrated circuit device, the method allowing stochastic defects in a pattern formation process using a photolithography process to be reduced by using a layout modification method that is capable of reducing the area of a layout including a minimum-pitch pattern even without increasing the whole area of a designed chip in an MDP process for converting designed layout information into data required for photomask fabrication.

According to an aspect of the inventive concept, there is provided a layout modification method including extracting a plurality of first pitch regions each including a plurality of first patterns from a layout of a target to be modified, through at least one loop process, performing a first modification to generate a first modified layout by shifting a position of at least one first pattern selected from the plurality of first patterns of each of the plurality of first pitch regions, after the first modification is performed, extracting a plurality of second pitch regions each including a plurality of second patterns from the first modified layout, classifying the plurality of second pitch regions into a plurality of pitch region groups according to widths of the plurality of second patterns in a pitch direction of the plurality of second patterns, and performing a second modification to generate a second modified layout by shifting a position of at least one second pattern selected from the plurality of second patterns of each of the plurality of second pitch regions, in descending order starting from a pitch region group having a maximum width in the pitch direction of the plurality of second patterns from among the plurality of pitch region groups. To manufacture an integrated circuit device, the layout modification method is used.

According to another aspect of the inventive concept, there is provided a layout modification method including extracting a plurality of first pitch regions each including a plurality of first patterns from a layout of a target to be modified, performing a first modification to generate a first modified layout in which positions of some of the plurality of first patterns are shifted such that space widths between each of the plurality of first patterns are not constant in a pitch direction of the plurality of first patterns, by shifting a position of at least one first pattern selected from the plurality of first patterns in each of the plurality of first pitch regions, after the first modification is performed, extracting a plurality of second pitch regions each including a plurality of second patterns from the first modified layout, classifying the plurality of second pitch regions into a plurality of pitch region groups according to widths of the plurality of second patterns in a pitch direction of the plurality of second patterns, and performing a second modification to generate a second modified layout by shifting a position of at least one second pattern selected from the plurality of second patterns of each of the plurality of second pitch regions, in descending order starting from a pitch region group having a maximum width in the pitch direction of the plurality of second patterns from among the plurality of pitch region groups, wherein, after the second modification is performed, all space widths between each of the plurality of second patterns are greater in the pitch direction of the plurality of second patterns than the space widths between each of the plurality of first patterns.

According to another aspect of the inventive concept, there is provided a method of manufacturing an integrated circuit device, the method including designing a layout, extracting a plurality of first pitch regions each including a plurality of first patterns from the layout, through at least one loop process, performing a first modification to generate a first modified layout by shifting a position of at least one first pattern selected from the plurality of first patterns of each of the plurality of first pitch regions, after the first modification is performed, extracting a plurality of second pitch regions each including a plurality of second patterns from the first modified layout, classifying the plurality of second pitch regions into a plurality of pitch region groups according to widths of the plurality of second patterns in a pitch direction of the plurality of second patterns, performing a second modification to generate a second modified layout by shifting a position of at least one second pattern selected from the plurality of second patterns of each of the plurality of second pitch regions, in descending order starting from a pitch region group having a maximum width in the pitch direction of the plurality of second patterns from among the plurality of pitch region groups, performing optical proximity correction (OPC) on the second modified layout, fabricating a photomask by using a resulting product obtained by performing the OPC on the second modified layout, and forming a plurality of interconnection lines on a substrate by using the photomask.

### BRIEF DESCRIPTION OF THE DRAWINGS

Embodiments will be more clearly understood from the following detailed description taken in conjunction with the accompanying drawings in which:

FIG. 1A is a diagram illustrating area distribution ratios of patterns having widths of 20 nm and patterns having other widths in an example of a layout;

FIG. 1B is a diagram illustrating area distribution ratios of patterns having pitches of 36 nm and patterns having other pitches in an example of a layout;

FIG. 2 is a flowchart illustrating a method of manufacturing an integrated circuit device, according to example embodiments;

FIG. 3 is a pattern layout illustrating a layout modification method according to example embodiments;

FIGS. 4A, 4B, and 4C are plan views respectively illustrating a sequence of processes of rearranging a plurality of vias, which deviate from optimum positions, at the optimum positions by pattern modification of an upper interconnection pattern;

FIGS. 5 to 8 are each a pattern layout illustrating a layout modification method according to example embodiments;

FIG. 9 is a flowchart illustrating a simple pitch enlargement process;

FIGS. 10A, 10B, 11A, 11B, 12A, 12B, and 13 are each a pattern layout illustrating a simple pitch enlargement process;

FIG. 14 is a flowchart illustrating a pitch enlargement method of a pattern, according to example embodiments;

FIGS. 15, 16A, 16B, 17A, 17B, and 18 are each a pattern layout illustrating the pitch enlargement method of a pattern, which is shown in FIG. 14;

FIG. 19 is a flowchart illustrating a pitch enlargement method of a pattern, according to example embodiments;

FIGS. 20, 21A, 21B, 22A, 22B, 22C, 22D, 23A, 23B, 24, 25A, and 25B are each a pattern layout illustrating the pitch enlargement method of a pattern, which is shown in FIG. 19;

FIG. 26 is a flowchart illustrating a method of manufacturing an integrated circuit device, according to example embodiments;

FIG. 27 is a graph obtained by evaluating area distributions of patterns having pitches less than 45 nm in layouts each including a plurality of patterns arranged at various pitches; and

FIG. 28 is a graph illustrating results of evaluating how many jogs there are in each of the layouts used in the evaluation of FIG. 27.

### DETAILED DESCRIPTION OF THE EMBODIMENTS

Hereinafter, example embodiments of the inventive concept will be described in detail with reference to the accompanying drawings. Like components are denoted by like reference numerals throughout the specification, and repeated descriptions thereof are omitted.

A design rule of a large-scale integration (LSI) layout defines the width of a pattern and a minimum size of a space between patterns to ensure the manufacturing yield of an LSI device. That is, a minimum pitch defined as the sum of an available minimum width and an available minimum space may be used for an LSI layout, and a minimum pitch size in the design rule may be set depending on a resolution limit of lithography. A resolution limit size may be determined from the size of a pattern that is able to be manufactured with a sufficiently large process window.

In recent extreme ultraviolet (EUV) lithography, it is increasingly difficult to ensure patterning yield only by specifying a minimum size in a process window due to an issue of stochastic defects. For example, before EUV photolithography processes were used, when a pattern having a pitch of 36 nm (a width=20 nm and a space=16 nm) could be manufactured with a relatively large process window without any issue, it has been considered that the pattern could be formed without particular defects except for particle defects. However, in pattern formation processes using EUV photolithography processes, fatal defects, such as open defects and bridge defects, may be stochastically generated regardless of particles. As the area of a layout region including minimum-pitch patterns gets larger, the defects stated above are generated more. Such defects are not caused by local process changes, such as changes in exposure doses (resist sensitivity) or focuses, but are stochastically generated.

Although a reduction in the area of a region having a small pitch size in a layout may lead to improving LSI manufacturing yield, influences of particle defects need to be reduced to achieve this effect. Therefore, by enlarging a pitch size of a layout on a large scale, for example, enlarging a minimum pitch to twice the minimum pitch, an effect of reducing an influence of particle defects may be achieved. On the other hand, the probability of generation of the stochastic defects stated above may significantly vary even due to a small size difference of about 0.5 nm to about 1 nm. According to the inventive concept, by enlarging a pitch size, for example, enlarging the pitch size from 36 nm to 37 nm, the defect issue stated above may be solved. The pitch size enlarged as such may correspond to about 2% to about 5% of the minimum pitch.

A layout for forming an interconnection layer of state-of-the-art LSI is generated by an automatic routing tool, and here, almost all patterns are arranged on tracks arranged at equal intervals. The size of a track corresponds to the minimum size. Most of the layout for forming the interconnection layer may include patterns having the minimum pitch. Here, an analysis result of an example of a layout of state-of-the-art LSI (for example, a 4 nm node) is as follows. The layout may be designed with rules of a minimum width of 20 nm and a minimum space of 16 nm.

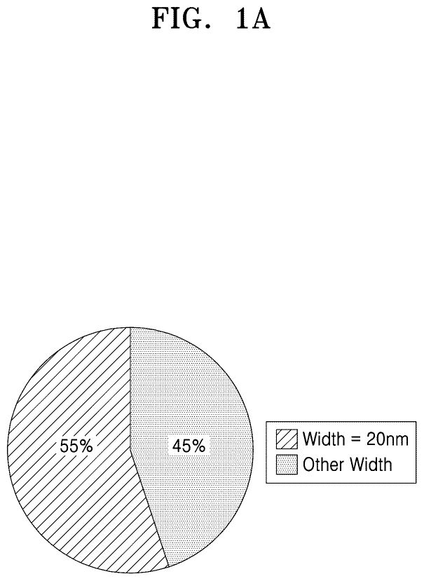

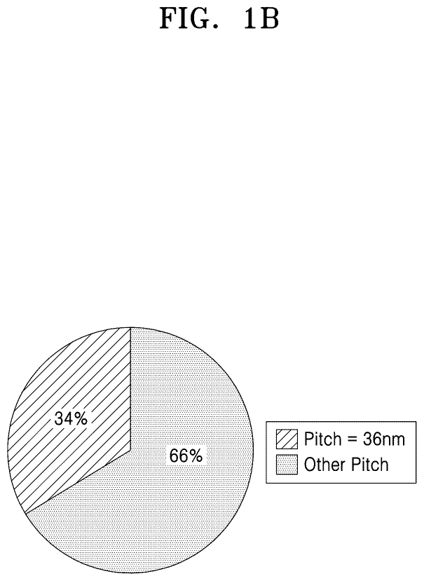

FIG. 1A is a diagram illustrating area distribution ratios of patterns having widths of 20 nm and patterns having other widths in an example of a layout. In FIG. 1A, it may be seen that patterns having a width of 20 nm occupy approximately half (e.g., 55%) of the area of the layout. In addition, pitch distribution analysis was performed on the patterns having widths of 20 nm.

FIG. 1B is a diagram illustrating area distribution ratios of patterns having pitches of 36 nm and patterns having other pitches in an example of a layout. In FIG. 1B, it is shown that about ⅔ of the area of the patterns having widths of 20 nm are occupied by the patterns having a pitch of 36 nm. Therefore, it may be understood that stochastic defects generated in a minimum-pitch layout are a serious issue in state-of-the-art LSI.

To solve such an issue, when a minimum pitch size defined in a design rule is enlarged from the beginning, the area of an LSI chip may increase, thereby resulting in economic losses. The inventive concept provides a layout modification method capable of reducing the area of a layout including a minimum-pitch pattern even without increasing the whole area of a designed chip. The layout modification method according to the inventive concept includes a process of increasing a pitch size by locally shifting some of patterns having a minimum pitch while maintaining the functionality of an LSI chip during the process of mask data preparation.

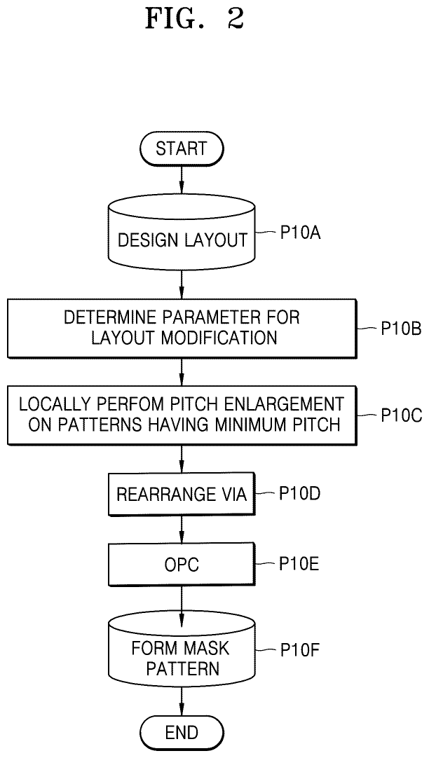

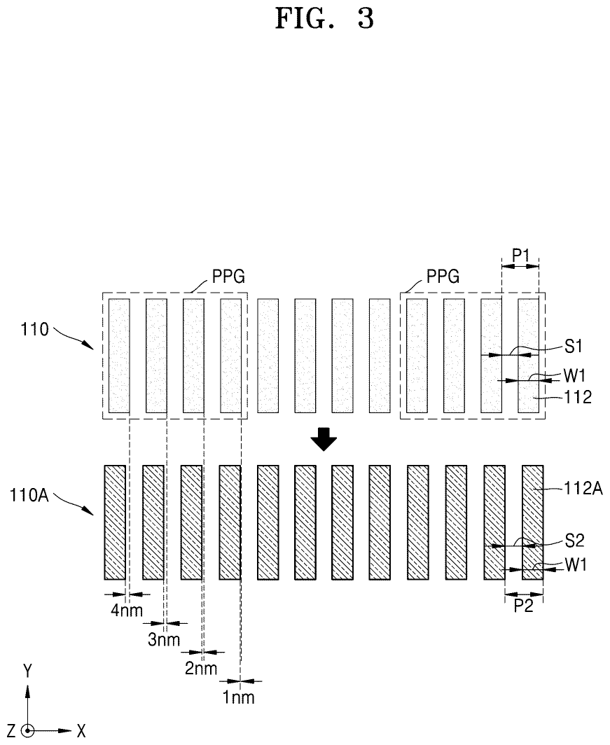

FIG. 2 is a flowchart illustrating a method of manufacturing an integrated circuit device, according to example embodiments of the inventive concept. FIG. 3 is a pattern layout illustrating a layout modification method according to example embodiments of the inventive concept.

Referring to FIGS. 2 and 3, in process P10A, a pattern layout 110 may be designed. In some embodiments, the pattern layout 110 may include a layout of an interconnection layer pattern. Therefore, a plurality of patterns 112 in the pattern layout 110 may be arranged on tracks that are arranged at equal intervals in a first horizontal direction (an X direction).

In process P10B of FIG. 2, two main parameters for modifying a designed layout may be determined. One of the main parameters may be a pitch enlargement size (EPS), and the other one may be a maximum allowable pattern shift size (MAPS).

The relationship between the EPS and the MAPS is described with reference to FIG. 3. FIG. 3 illustrates the pattern layout 110, which is the layout designed in process P10A of FIG. 2 and includes the plurality of patterns 112, and also illustrates a pattern layout 110A including a plurality of modified patterns 112A obtained by locally pitch-enlarging the plurality of patterns 112 having a minimum pitch according to process P10C of FIG. 2, which is described below. FIG. 3 shows an example in which the plurality of patterns 112 having a first pitch P1 of 36 nm under the condition of MAPS=4 nm are pitch-enlarged into the plurality of modified patterns 112A having a second pitch P2 of 37 nm (EPS=1 nm).

In the example of FIG. 3, the designed pattern layout 110 includes twelve patterns 112 each having a pattern width W1 of 20 nm, and a space width S1 between each of the twelve patterns 112 is 16 nm. Within a limit of MAPS=4 nm, the pitch of a peripheral pattern group PPG, which includes eight patterns 112 selected from outside each of the left and right sides of the pattern layout 110, may be enlarged. The pattern layout 110A, which includes the plurality of modified patterns 112A that are locally pitch-enlarged, include twelve modified patterns 112A each having a pattern width W1 of 20 nm, and a space width S2 between each of the twelve modified patterns 112A is 17 nm.

It was confirmed through various evaluations that, by rearranging a via at an optimum position in a via rearrangement process performed in subsequent process P10D, the patterns 112 may be moved by as much as about 10% of the minimum pitch without adversely affecting the LSI functionality. In some embodiments, the MAPS may be 15% or less of the minimum pitch.

In process P10C of FIG. 2, some patterns 112 from among the plurality of patterns 112 may be locally shifted according to the EPS and the MAPS that are preset, thereby reducing the area of a region (a minimum-pitch region) including patterns having the minimum pitch in the pattern layout 110 that is input. Here, although the area occupied by the minimum-pitch region needs to be made as small as possible, it needs to be avoided to generate too many small jogs due to pattern modification. The reason for this is because there is a high possibility that the small jogs become hot spots vulnerable to an optical proximity correction (OPC) process according to subsequent process P10E of FIG. 2. To reduce the area of the region (the minimum-pitch region) including patterns having the minimum pitch in the pattern layout 110 according to process P10C of FIG. 2, the layout modification method according to embodiments, as described below, may be applied.

In process P10D of FIG. 2, to ensure the connection between upper interconnection patterns and lower interconnection patterns, a via may be rearranged, the via being a contact plug for the connection between an upper interconnection pattern and a lower interconnection pattern. The optimum position of the via is a center of an intersection region between the upper interconnection pattern and the lower interconnection pattern.

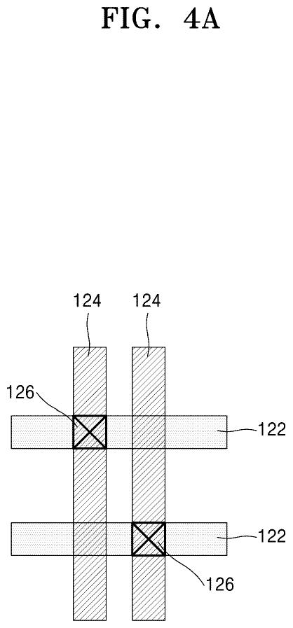

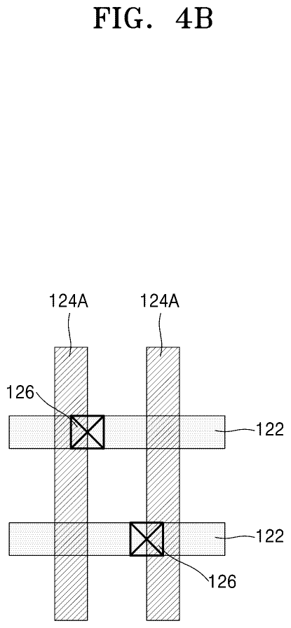

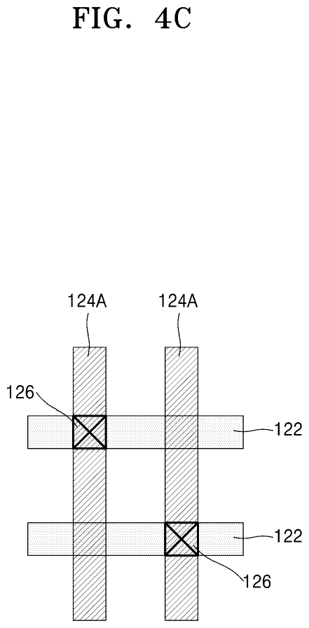

FIGS. 4A, 4B, and 4C are plan views respectively illustrating a sequence of processes of rearranging a plurality of vias 126, which deviate from optimum positions, at the optimum positions by pattern modification of an upper interconnection pattern 124.

More specifically, FIG. 4A is a planar layout of a plurality of lower interconnection patterns 122, a plurality of upper interconnection patterns 124 arranged over the plurality of lower interconnection patterns 122 to intersect the plurality of lower interconnection patterns 122 and designed according to process P10A of FIG. 2, and a plurality of vias 126 connected between the plurality of lower interconnection patterns 122 and the plurality of upper interconnection patterns 124.

FIG. 4B is a planar layout of a plurality of modified upper interconnection patterns 124A obtained after the plurality of upper interconnection patterns 124 are pitch-enlarged according to process P10C of FIC. 2, the plurality of lower interconnection patterns 122, and the plurality of vias 126. In FIG. 4B, as the modified upper interconnection patterns 124A have undergone a pitch change and thus a position movement, each of the plurality of vias 126 deviates from the optimum position thereof, that is, a center position of an intersection region between a modified upper interconnection pattern 124A and the lower interconnection pattern 122.

FIG. 4C is a planar layout of the plurality of modified upper interconnection patterns 124A obtained after the plurality of vias 126 are repositioned according to process P10D, the plurality of lower interconnection patterns 122, and the plurality of vias 126. In FIG. 4C, by repositioning the plurality of vias 126, each of the plurality of vias 126 may be at the optimum position thereof, that is, the center position of the intersection region between the modified upper interconnection pattern 124A and the lower interconnection pattern 122.

In process P10E of FIG. 2, general process window (PW) OPC may be performed on a resulting product in which the via is repositioned according to process P10D of FIG. 2. The PW OPC may be performed to optimize a trade-off between opening and bridging by using a space generated by pitch enlargement. Therefore, a mask pattern layout resistant to process deviations may be generated by a combination of the pitch enlargement and the PW OPC.

In process P10F of FIG. 2, a mask pattern may be formed based on the mask pattern layout having reflected the PW OPC performed according to process P10E of FIG. 2.

The method, described with reference to FIGS. 2 and 3, of manufacturing an integrated circuit device includes a process of locally pitch-enlarging patterns having a minimum pitch according to process P10C. Hereinafter, a pitch enlargement process according to process P10C of FIG. 2 is described in more detail.

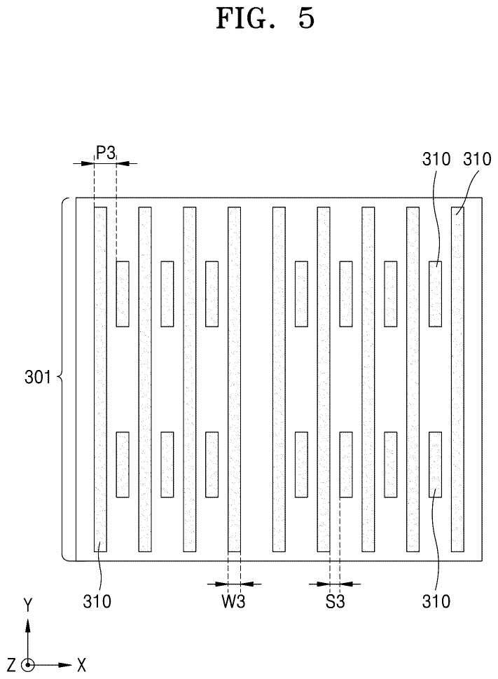

An example of the pitch enlargement process according to process P10C of FIG. 2 is described by taking an example in which a pattern layout 301 shown in FIG. 5 is used as an input pattern layout. In FIG. 5, the pattern layout 301 includes a plurality of patterns 310, each having a width W3 of 20 nm in the first horizontal direction (the X direction). A space width S3 in the first horizontal direction (the X direction) between two adjacent patterns 310 from among the plurality of patterns 310 is 16 nm, and the plurality of patterns 310 are arranged at a pitch P3 of 36 nm in the first horizontal direction (the X direction).

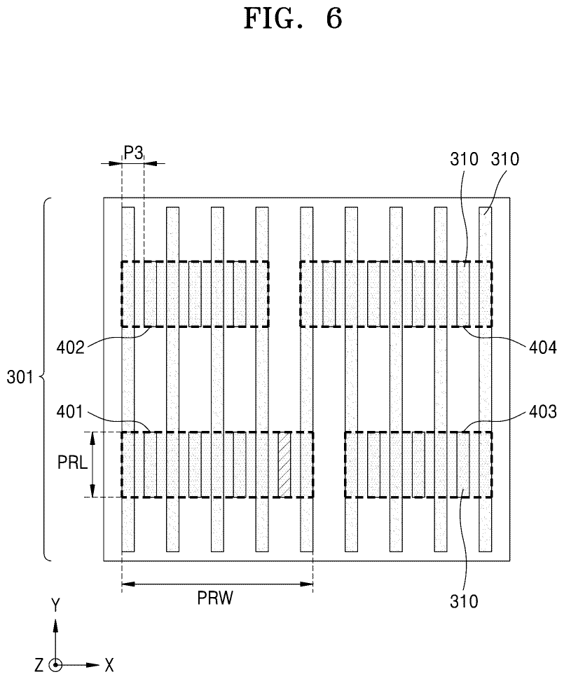

As shown in FIG. 6, the pattern layout 301 includes four pitch regions, that is, first to fourth pitch regions 401, 402, 403, and 404. In the present example, the pitch P3 of the plurality of patterns 310 of the pattern layout 301 is enlarged from 36 nm to 37 nm under the condition of MAPS=4 nm. The length of each of the first to fourth pitch regions 401, 402, 403, and 404 in a pitch direction, which is the first horizontal direction (the X direction), is referred to as a pitch region width PRW, and the length of each of the first to fourth pitch regions 401, 402, 403, and 404 in a second horizontal direction (a Y direction), which is perpendicular to the first horizontal direction (the X direction), is referred to as a pitch region length PRL.

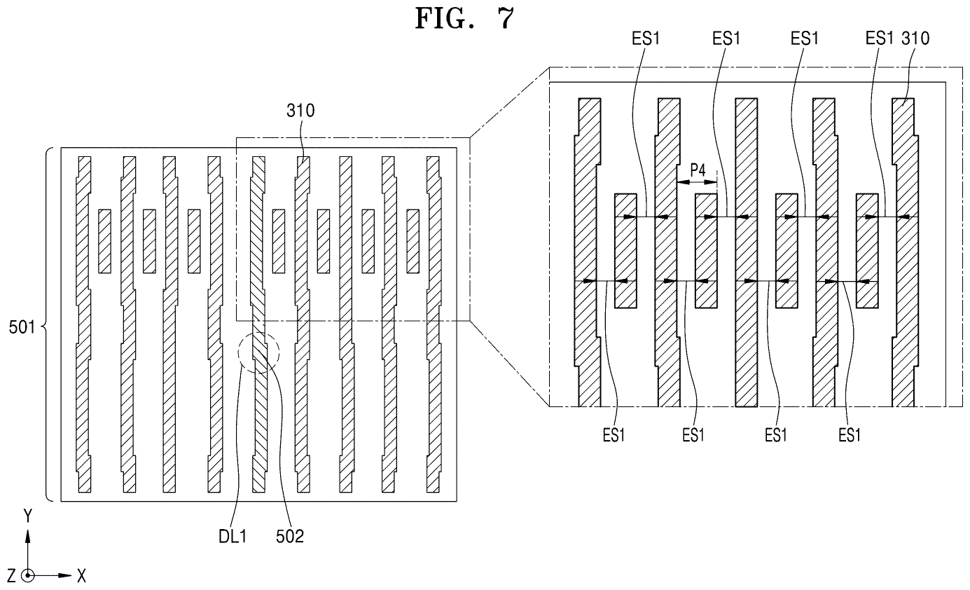

FIG. 7 illustrates a pattern layout 501 that is pitch-enlarged by using a simple algorithm. FIG. 7 shows an example of modifying only a region, in which the plurality of patterns 310 are arranged at the pitch P3 of 36 nm, and a pattern portion therearound in the pattern layout 301 of FIGS. 5 and 6 by a simple pitch enlargement process. In FIG. 7, an enlarged space width ES1 between two adjacent patterns 310 from among the plurality of patterns 310 in a pitch-enlarged region of the plurality of patterns 310 is 17 nm, and a pitch P4 of the plurality of patterns 310 in the pitch-enlarged region is increased to 37 nm.

As shown in a region indicated by a dashed circle DL1 in FIG. 7, small jogs 502 are generated around the pitch-enlarged region of the plurality of patterns 310. There are 32 jogs 502 in the pattern layout 501 shown in FIG. 7. Although the pitch enlargement of the plurality of patterns 310 may be taken into account for improvement of a crucial region and other purposes, there is a need to also take into account a side effect of the generation of jogs. For example, to improve the manufacturing yield of an integrated circuit device, when the pitch enlargement is applied to a certain region of a layout including a plurality of patterns, small jogs may be generated around the pitch-enlarged region. However, the small jogs act as a cause of generating hot spots vulnerable to an OPC process, and thus, it may be difficult to achieve accurate OPC for forming patterns that have sizes equal to or less than a resolution limit size. Therefore, there is a need to prevent the generation of jogs or reduce the number of generated jogs as much as possible due to the pitch enlargement of patterns by modifying the pitch of the patterns according to the layout modification method according to embodiments.

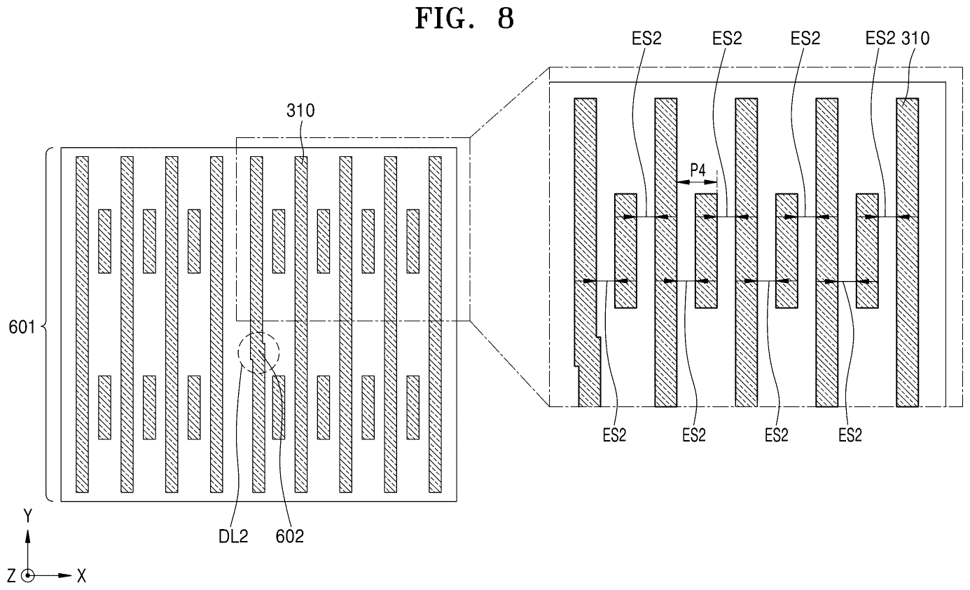

FIG. 8 illustrates a pattern layout 601 that is pitch-enlarged according to a layout modification method according to embodiments. In FIG. 8, an enlarged space width ES2 between two adjacent patterns 310 from among the plurality of patterns 310 in a pitch-enlarged region of the plurality of patterns 310 is 17 nm.

In the pattern layout 601 shown in FIG. 8, although the pitch of the plurality of patterns 310 of the pattern layout 301 of FIGS. 5 and 6 is increased from the pitch P3 of 36 nm to a pitch P4 of 37 nm, there is only one jog 602 around the pitch-enlarged region of the plurality of patterns 310, as shown in a region indicated by a dashed circle DL2 in FIG. 8. An aspect of the inventive concept is to provide a pitch enlargement method of patterns, the pitch enlargement method being capable of providing a result of minimizing the generation of jogs as in the pattern layout 601 shown in FIG. 8. That is, according to the inventive concept, the area occupied by a minimum-pitch region in a layout may be reduced as much as possible while preventing or minimizing the generation of jogs as much as possible.

Before the pitch enlargement method of patterns, by which a resulting product having minimized the generation of jogs as in the pattern layout 601 shown in FIG. 8 may be obtained from the pattern layout 301 shown in FIG. 5, is described, a method (which may be referred to as a “simple pitch enlargement process”, herein) of forming the pattern layout 501 shown in FIG. 7 from the pattern layout 301 shown in FIG. 5 is described first.

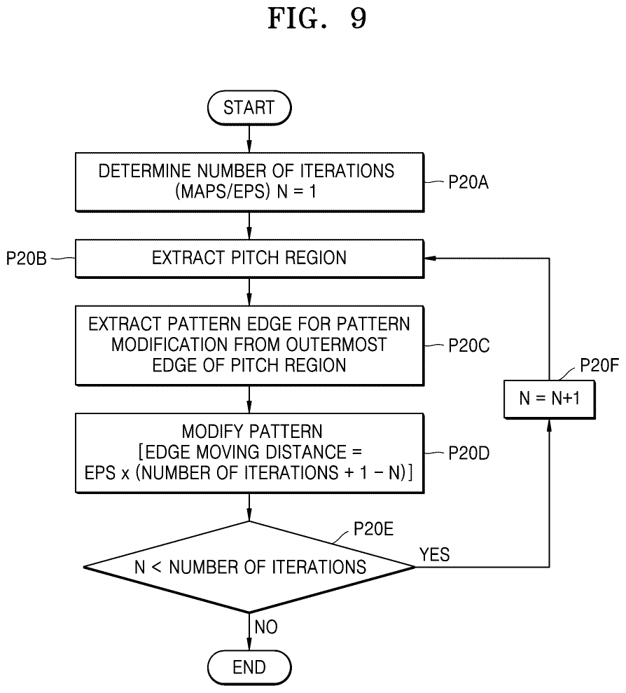

FIG. 9 is a flowchart illustrating a simple pitch enlargement process. Hereinafter, a pitch enlargement method according to the simple pitch enlargement process is described with reference to FIG. 9 by using the pattern layout 301 shown in FIG. 5.

Referring to FIG. 9, first, in process P20A, the number of iterations of a loop process is determined. The number of iterations may be defined by the following equation.

Number of iterations=MAPS/EPS

In the case of the pattern layout 301 shown in FIG. 5, because MAPS=4 nm and EPS=1 nm according to the above equation, the number of iterations is 4.

In process P20B of FIG. 9, a pitch region, which is a target region to be pitch-enlarged, is extracted from the pattern layout 301. The pitch region in a first loop (N=1) may include the first to fourth pitch regions 401, 402, 403, and 404 shown in FIG. 6. In each of the first to fourth pitch regions 401, 402, 403, and 404, the length of each region in a pitch direction, which is the first horizontal direction (the X direction), is referred to as a pitch region width PRW (see FIG. 6), and the length of each region in a second horizontal direction (a Y direction), which is perpendicular to the first horizontal direction (the X direction), is referred to as a pitch region length PRL (see FIG. 6).

In process P20C of FIG. 9, pattern portions to be modified for pitch enlargement are extracted. The pattern portions to be modified may be defined from outermost edges in the pitch direction in each of the first to fourth pitch regions 401, 402, 403, and 404 shown in FIG. 6.

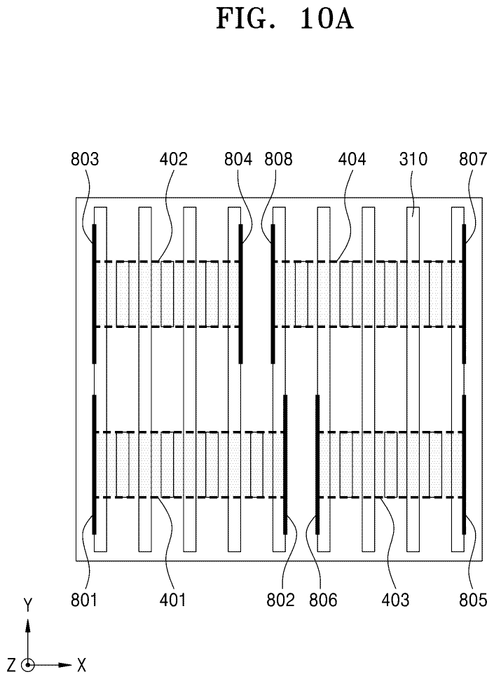

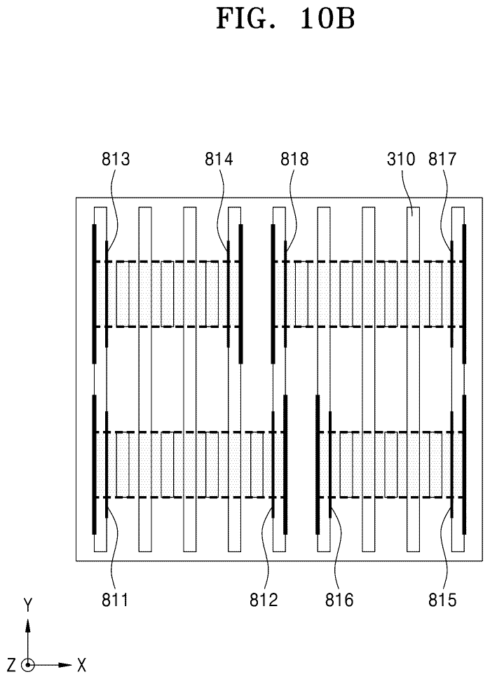

As shown in FIG. 10A, outer edges 801, 802, 803, 804, 805, 806, 807, and 808 of the patterns 310 for pitch enlargement may be extracted according to process P20C. The outer edges 801, 802, 803, 804, 805, 806, 807, and 808 may be defined by extending respective edges of input patterns, which are consistent with the outermost edges of the pitch regions, in the second horizontal direction (the Y direction) so as to be greater than the pitch region length PRL.

Next, as shown in FIG. 10B, inner edges 811, 812, 813, 814, 815, 816, 817, and 818, which respectively form pairs with the outer edges 801, 802, 803, 804, 805, 806, 807, and 808, may be extracted. The outer edges 801, 802, 803, 804, 805, 806, 807, and 808 and the inner edges 811, 812, 813, 814, 815, 816, 817, and 818 may be referred to as temporary edges of portions required to be modified for pitch enlargement. Here, the length in the second horizontal direction (the Y direction) of each of the inner edges 811, 812, 813, 814, 815, 816, 817, and 818 needs to be less than the length of an edge corresponding to each inner edge from among the outer edges 801, 802, 803, 804, 805, 806, 807, and 808 and needs to be greater than the pitch region length PRL of a pitch region corresponding to each inner edge. The reason for this is because the distance between corners of modified patterns needs to be secured, and this is described below in more detail in process P20D of FIG. 9.

In process P20D of FIG. 9, it is checked whether there is a sufficient space in a direction for pitch enlargement, and then, pattern modification is performed.

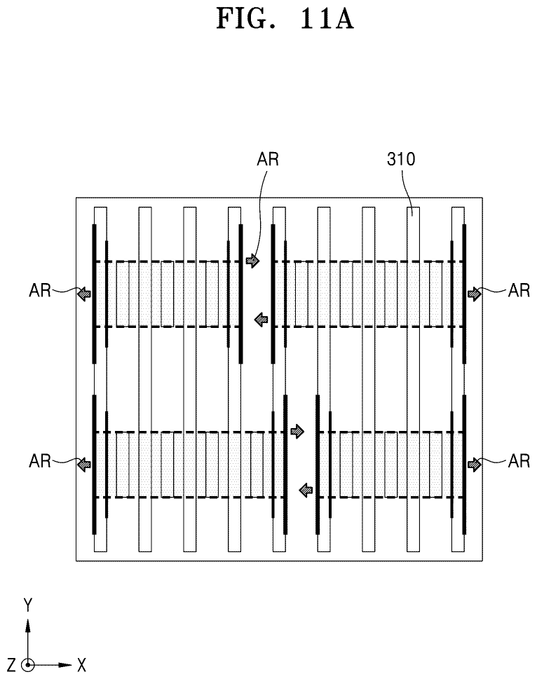

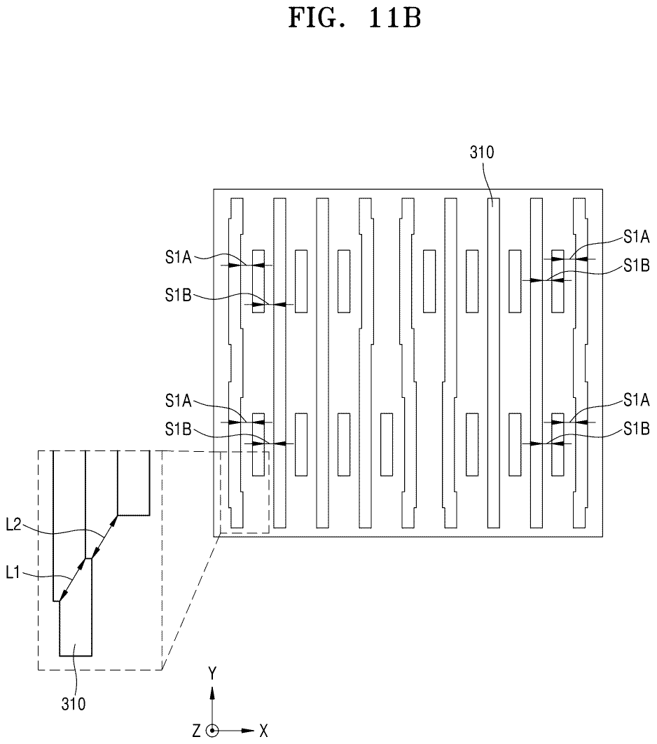

FIG. 11A is a layout illustrating a pitch enlargement direction for each of edges of a plurality of patterns 310, and FIG. 11B is a layout illustrating the plurality of patterns 310 pitch-enlarged according to the pitch enlargement direction shown in FIG. 11A. The pitch enlargement direction for each of the edges of the plurality of patterns 310 is the same as an edge movement direction indicated by each of arrows AR in FIG. 11A. For example, to achieve pitch enlargement, each of the edges needs to be shifted by as much as 4 nm in the first loop (N=1) in the processes according to the flowchart of FIG. 9. Therefore, after the edges are extracted, when it is unable to secure a sufficient space in the direction for pitch enlargement, edges allowed to be shifted by as much as 4 nm may be extracted again from the temporary edges.

In the example shown in FIG. 11A, because there are sufficient spaces in shift directions of all the outer edges 801, 802, 803, 804, 805, 806, 807, and 808, the input pattern is modified by shifting all the outer edges 801, 802, 803, 804, 805, 806, 807, and 808 and the inner edges 811, 812, 813, 814, 815, 816, 817, and 818 to obtain the layout shown in FIG. 11B. In FIG. 11B, a space width S1A is 20 nm, and a space width S1B is 16 nm.

As shown in the enlarged region in FIG. 11B, an internal distance L1 between corners in a jog of a pattern 310 needs to be greater than a minimum pattern width of the pattern 130 in the first horizontal direction (the X direction), and an external distance L2 between the corner of the jog and a corner of another pattern 310 adjacent to the corner of the jog needs to be greater than a minimum space width between respective straight portions of the plurality of patterns 310. When such a condition is not satisfied, OPC accuracy may deteriorate. Due to this reason, in process P20C of FIG. 9, the lengths of the outer edges 801, 802, 803, 804, 805, 806, 807, and 808 are respectively different in the second horizontal direction (the Y direction) from the lengths of the inner edges 811, 812, 813, 814, 815, 816, 817, and 818 in the second horizontal direction (the Y direction).

In process P20E of FIG. 9, it is checked whether a preset number of iterations have been performed. In FIG. 9, when the first loop (N=1) is completed, 1 is added to a loop counter N in process P20F, and the process of FIG. 9 returns to process P20B and performs a second loop (N=2) to repeat the same process. This process repeats until the number of iterations is equal to the present number of iterations.

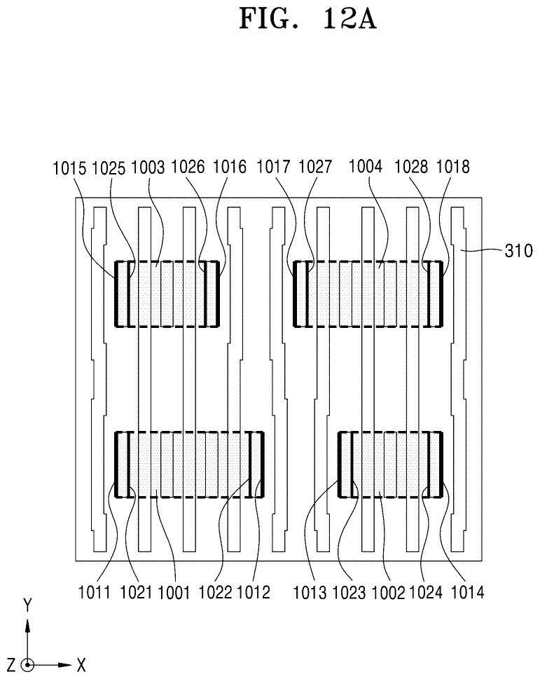

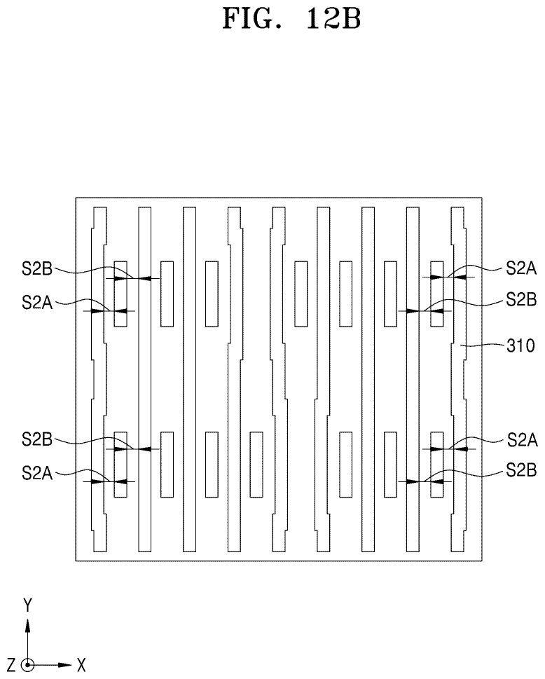

FIG. 12A is a layout of the plurality of patterns 310 obtained after process P20C is performed in the second loop (N=2) of FIG. 9. FIG. 12B is a layout of the plurality of patterns 310 obtained after process P20D of FIG. 9 is performed in the second loop (N=2) of FIG. 9. FIG. 12A illustrates a plurality of pitch regions 1001, 1002, 1003, and 1004, and outer edges 1011, 1012, 1013, 1014, 1015, 1016, 1017, and 1018 and inner edges 1021, 1022, 1023, 1024, 1025, 1026, 1027, and 1028, which are extracted from the plurality of pitch regions 1001, 1002, 1003, and 1004. Here, the length of each of the plurality of pitch regions 1001, 1002, 1003, and 1004 is equal to the length of each of the outer edges 1011, 1012, 1013, 1014, 1015, 1016, 1017, and 1018 and the inner edges 1021, 1022, 1023, 1024, 1025, 1026, 1027, and 1028. Therefore, the length of each of the outer edges 1011, 1012, 1013, 1014, 1015, 1016, 1017, and 1018 and the inner edges 1021, 1022, 1023, 1024, 1025, 1026, 1027, and 1028 is the whole length of each input pattern. That is, all the input patterns are going to be moved for pitch enlargement.

The edge movement distance in each of a plurality of loops repeated in FIG. 9 is defined by Equation (1) as shown below.

Edge movement distance for pitch enlargement=EPS×(number of iterations+1−N). [Equation (1)]

In Equation (1), N is a loop counter, and the number of iterations is defined by MAPS/EPS. When MAPS=4 nm and EPS=1 nm, the number of iterations is 4.

Therefore, the edge movement distance in the second loop (N=2) in FIG. 9 is 3 nm, and the layout of FIG. 12B may be obtained after process P20D of FIG. 9 is performed. In FIG. 12B, a space width S2A is 17 nm, and a space width S2B is 19 nm.

Processes P20B, P20C, and P20D of FIG. 9 may be repeatedly performed up to a fourth loop (N=4), thereby obtaining the layout shown in FIG. 7.

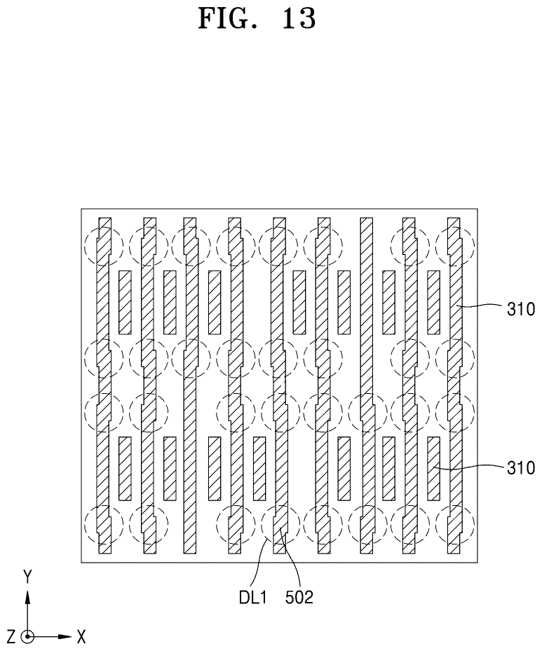

FIG. 13 is a pattern layout illustrating jogs that are generated in the layout obtained after processes P20B, P20C, and P20D of FIG. 9 are repeatedly performed up to a fourth loop (N=4) in FIG. 9. As indicated by a plurality of dashed circles DL1 in FIGS. 13, 32 small jogs 502 may be generated in the plurality of patterns 310 around pitch enlargement regions in the pattern layout shown in FIG. 7.

In process P20E of FIG. 9, when the set number of iterations have been performed, the process of FIG. 9 is terminated.

Next, a pitch enlargement method of patterns, according to embodiments, is described, the pitch enlargement method allowing no jog to be generated or the generation of jogs to be minimized.

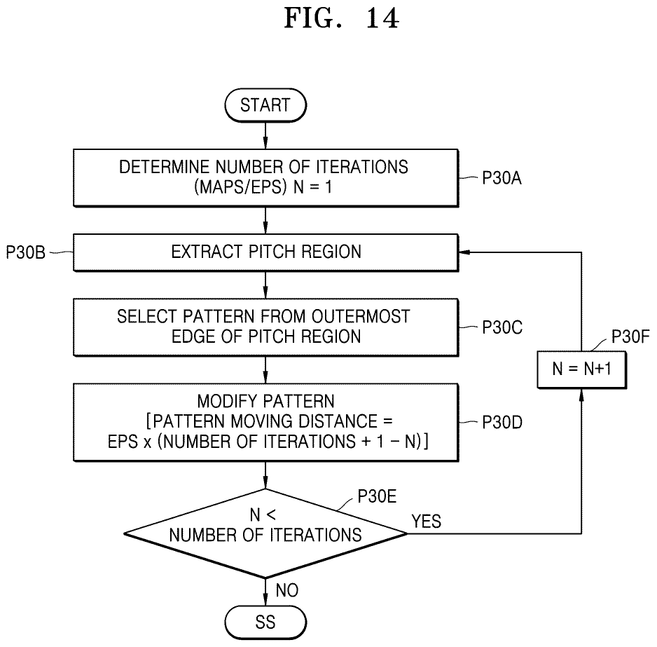

FIG. 14 is a flowchart illustrating a pitch enlargement method of patterns, according to embodiments. Herein, the pitch enlargement method of patterns according to FIG. 14 may be referred to as a “jog-generation avoidance process”. In the present method, all portions of an extracted pattern are shifted to avoid the generation of jogs.

In process P30A of FIG. 14, the number of iterations of a loop process is determined. The number of iterations may be defined by Equation (2) as shown below.

Number of iterations=MAPS/EPS [Equation (2)]

In process P30B of FIG. 14, a pitch region, which is a target region to be pitch-enlarged, is extracted from a layout of a target to be modified. The layout of the target to be modified may include a plurality of patterns. The pitch region, which is a target region to be pitch-enlarged, may include a plurality of patterns arranged in a line in a pitch direction. A detailed configuration of process P30A of FIG. 14 is the same as that of process P20A of FIG. 9 described above, and a detailed configuration of process P30B of FIG. 14 is the same as that of process P20B of FIG. 9 described above.

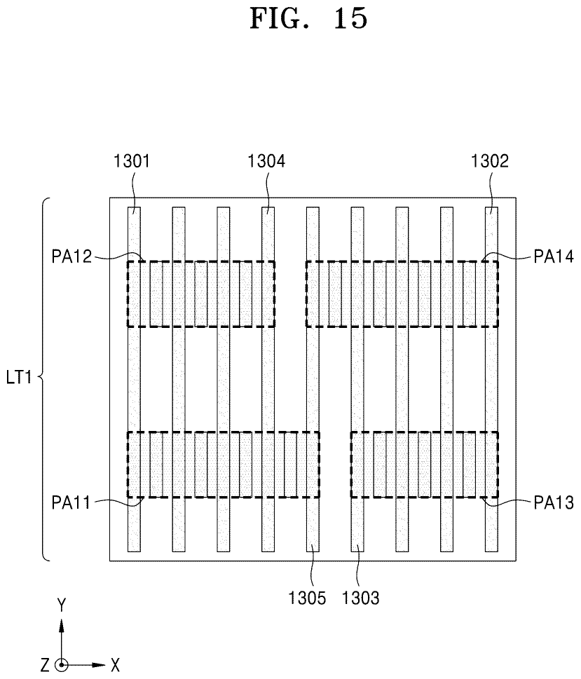

In process P30C of FIG. 14, in the pitch direction of the plurality of patterns, a pattern having an edge shared by an outermost edge of the selected pitch region is selected from among the plurality of patterns in the selected pitch region. For example, first to fourth pitch regions PA11, PA12, PA13, and PA14 may be extracted from a pattern layout LT1 of FIG. 15. In a pitch direction, which follows the first horizontal direction (the X direction), of a plurality of patterns in each of the first to fourth pitch regions PA11, PA12, PA13, and PA14, patterns 1301, 1302, 1303, 1304, and 1305 each having an edge shared by an outermost edge of each of the first to fourth pitch regions PA11, PA12, PA13, and PA14 may be selected from among the plurality of patterns.

The plurality of patterns, which are included in each of the first to fourth pitch regions PA11, PA12, PA13, and PA14, may respectively have lengths that are not consistent in the second horizontal direction (the Y direction) perpendicular to the pitch direction of the plurality of patterns. The length of each of the first to fourth pitch regions PA11, PA12, PA13, and PA14 in the second horizontal direction (the Y direction) may be equal to the length of a pattern having a minimum length in the second horizontal direction (the Y direction) from among the plurality of patterns.

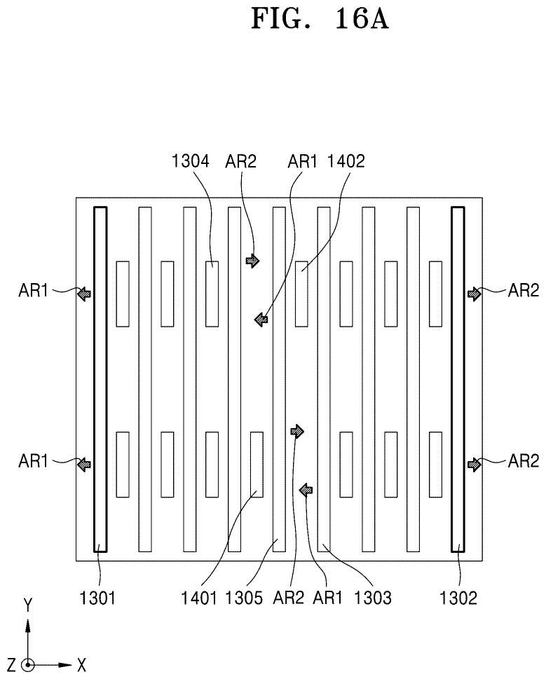

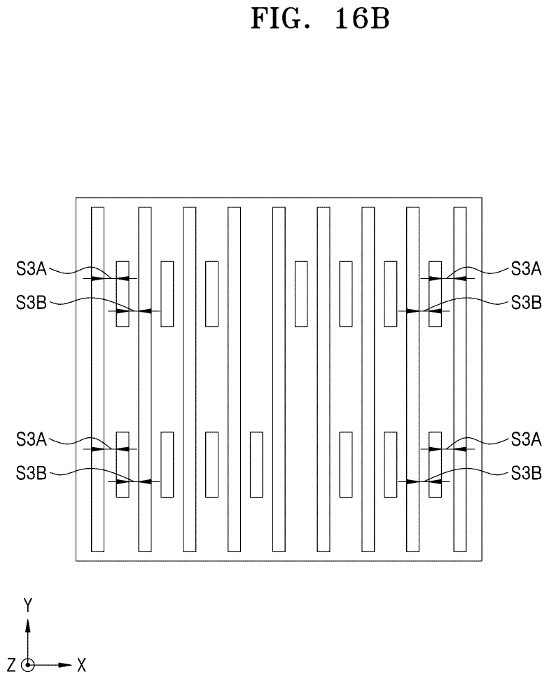

In process P30D of FIG. 14, similar to process P20D of FIG. 9, it is checked whether there is a sufficient space in a direction for pitch enlargement, and then, pattern modification is performed. However, in the present method, all the patterns selected are shifted for pitch enlargement. A movement direction is the same as described in process P20C of FIG. 9. That is, movement directions of the selected patterns 1301, 1302, 1303, 1304, and 1305 are the same as respectively indicated by arrows AR1 and AR2 in FIG. 16A.

FIG. 16A is a layout illustrating pattern movement according to process P30D in a first loop of FIG. 14, and FIG. 16B is a layout having undergone modification according to the pattern movement according to process P30D in the first loop of FIG. 14.

In FIG. 16A, the movement directions of the selected patterns 1301, 1302, 1303, 1304, and 1305 are respectively indicated by the arrows AR1 and AR2. Each of the arrows AR1 indicates movement in a −X direction in FIG. 16A, and each of the arrows AR2 indicates movement in a +X direction in FIG. 16A. Referring to FIG. 16A, because the movement of the pattern 1303 and the pattern 1304 may be respectively limited by a pattern 1401 and a pattern 1402 respectively adjacent to the pattern 1303 and the pattern 1304, there may be an insufficient space to move each of the pattern 1303 and the pattern 1304. The movement of the pattern 1305 in both directions (that is, the −X direction and the +X direction) in the pitch direction may be limited by the pattern 1401 and the pattern 1402. Therefore, in the layout of FIG. 16A, patterns capable of being sufficiently moved include only the pattern 1301 and the pattern 1302. FIG. 16B illustrates a layout after the pattern 1301 and the pattern 1302 in FIG. 16A are moved. In FIG. 16B, a space width S3A is 20 nm, and a space width S3B is 16 nm.

In process P30E of FIG. 14, it is checked whether a set number of iterations are performed. In FIG. 14, when the first loop (N=1) is completed, 1 is added to the loop counter N in process P30F, and the process of FIG. 14 returns to process P30B and performs a second loop (N=2) to repeat the same process.

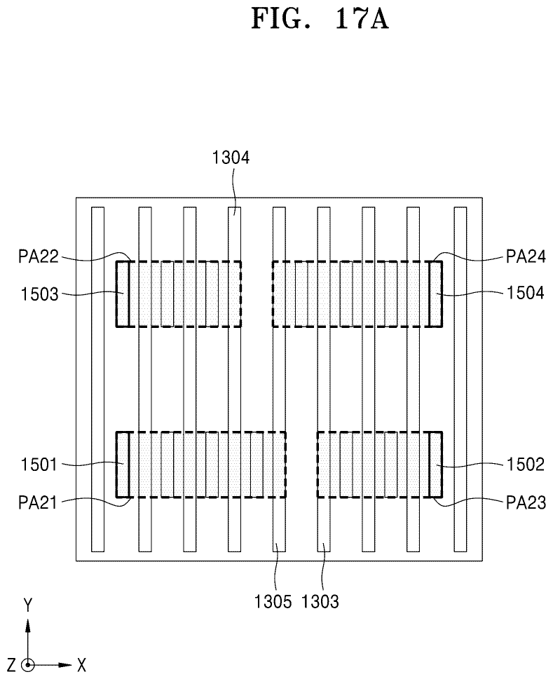

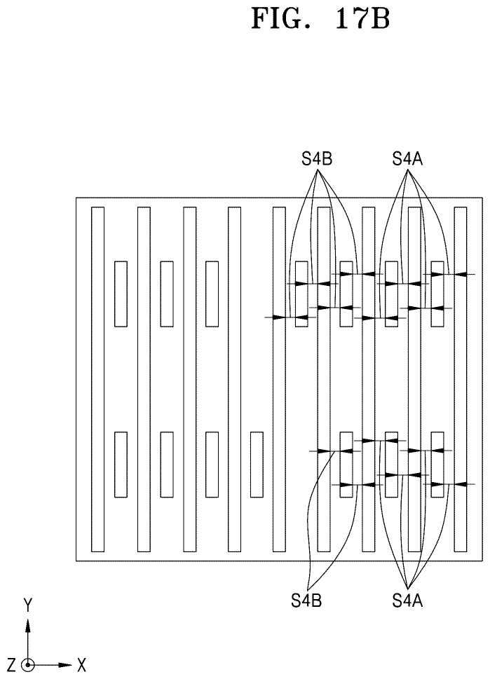

FIG. 17A is a layout of a plurality of patterns, the layout illustrating a result of performing process P30C in the second loop (N=2) of the process of FIG. 14. FIG. 17B is a layout of a plurality of patterns obtained after process P30D of FIG. 14 is performed in the second loop (N=2) of FIG. 14.

Referring to FIG. 17A, after process P30C is performed in the second loop of FIG. 14, conditions of the patterns 1303, 1304, and 1305 are respectively the same as described with reference to FIG. 16A regarding the conditions thereof after the first loop (N=1) of FIG. 14 is performed. That is, in first to fourth pitch regions PA21, PA22, PA23, and PA24 extracted from the layout of FIG. 17A, patterns capable of being sufficiently moved include only patterns 1501, 1502, 1503, and 1504. FIG. 17B illustrates a layout obtained after the patterns 1501, 1502, 1503, and 1504 are moved. In FIG. 17B, a space width S4A is 17 nm, and a space width S4B is 16 nm.

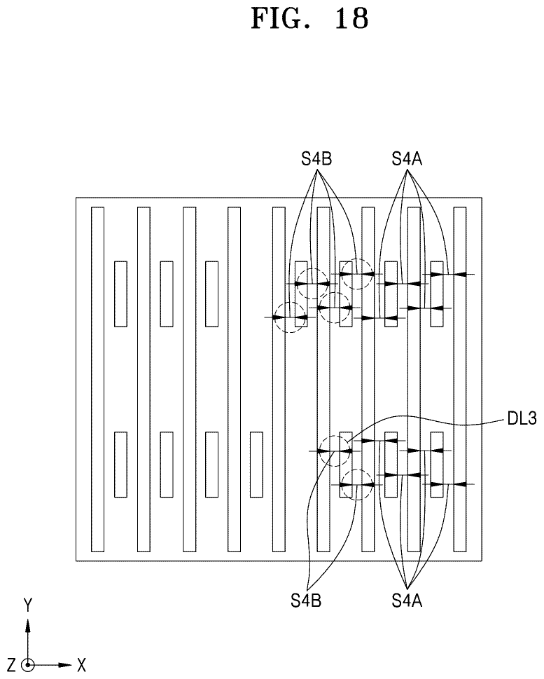

FIG. 18 is a layout obtained after process P30B, process P30C, and process P30D are repeated up to a fourth loop (N=4) in the process of FIG. 14. Even though process P30B, process P30C, and process P30D are repeated up to the fourth loop (N=4) in the process of FIG. 14, the patterns 1303, 1304, and 1305 of FIG. 17A are not able to be moved, and as a result, the final pattern layout shown in FIG. 18 may be obtained. As indicated by a plurality of dashed circles DL3 in the right area of FIG. 18, spaces not enlarged may remain between each of the plurality of patterns. Although not shown in FIG. 18, spaces not enlarged may also remain in the left area of FIG. 18, similar to the right area of FIG. 18. Each of the spaces not enlarged in FIG. 18 may have a space width of 16 nm. In process P30E of FIG. 14, when a set number of iterations have been performed, the process of FIG. 14 is terminated.

From the result of the jog-generation avoidance method described with reference to FIG. 14, it may be understood that the jog-generation avoidance method may more effectively reduce a minimum-pitch area.

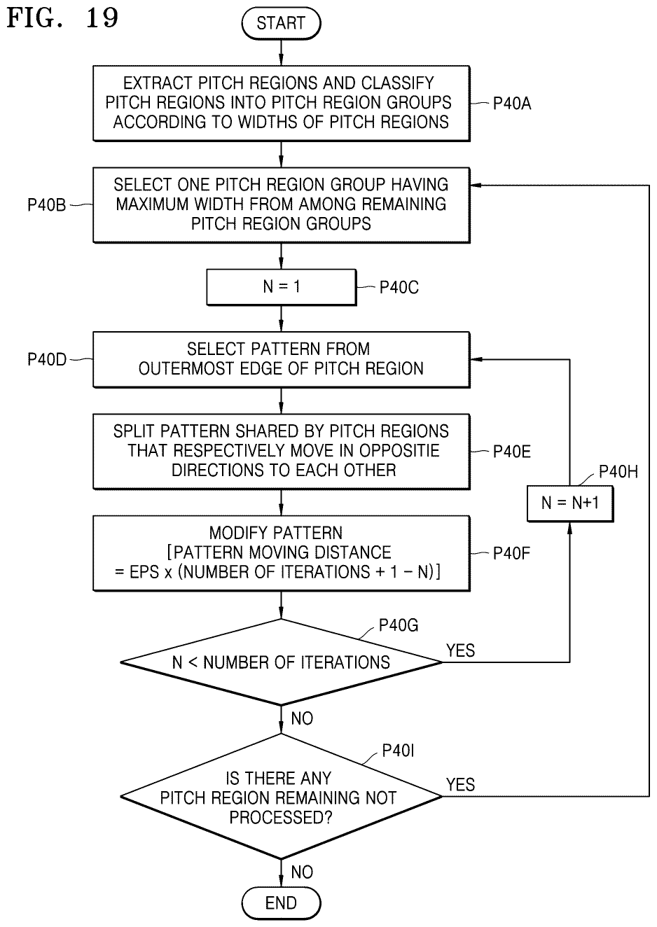

FIG. 19 is a flowchart illustrating a pitch enlargement method of patterns, according to some embodiments. The pitch enlargement method described with reference to FIG. 19 is substantially the same as the jog-generation avoidance method described above with reference to FIG. 14. However, a process described with reference to FIG. 19 is obtained by adding subsequent processes to the jog-generation avoidance method described with reference to FIG. 14, and herein, the process described with reference to FIG. 19 may be referred to as a “2-step process”. In the present example, by taking an example of the layout of FIG. 18, which is a resulting product having undergone pattern modification according to the process of FIG. 14, a method of modifying a pattern in the layout is described.

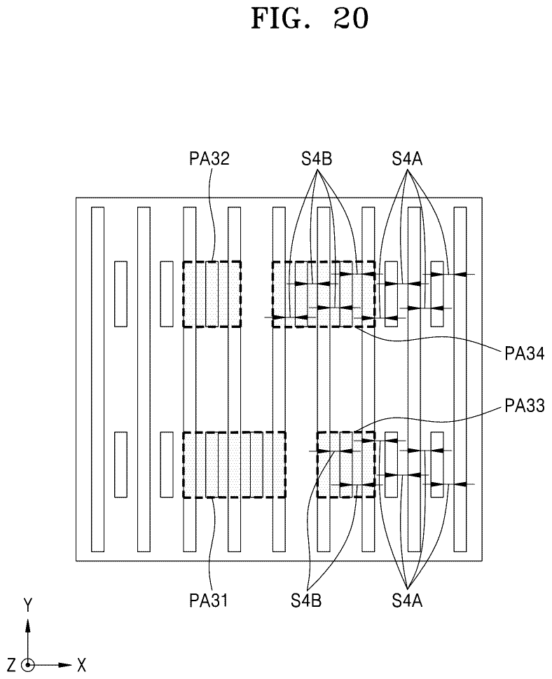

After the set number of iterations are performed in process P30E of FIG. 14, a plurality of pitch regions, for example, first to fourth pitch regions PA31, PA32, PA33, and PA34, may be extracted as shown in FIG. 20, in process P40A of FIG. 19. Next, the first to fourth pitch regions PA31, PA32, PA33, and PA34 are classified into a plurality of pitch region groups according to the width of each thereof in the first horizontal direction (the X direction) that is a pitch direction of each thereof. In the present example, the first to fourth pitch regions PA31, PA32, PA33, and PA34 are classified into two pitch region groups. One of the two pitch region groups is a first pitch region group including the first and fourth pitch regions PA31 and PA34, and the other one is a second pitch region group including the second and third pitch regions PA32 and PA33.

A rule for classifying the plurality of pitch regions into the plurality of pitch region groups is described below.

First, an example of classifying the plurality of pitch regions into a group A and a group B, which are two pitch region groups, is described. Here, a minimum value of the widths of the pitch regions falling within the group A is represented by Wmin(A), and a maximum value of the widths of the pitch regions falling within the group A is represented by Wmax(A). A minimum value of the widths of the pitch regions falling within the group B is represented by Wmin(B), and a maximum value of the widths of the pitch regions falling within the group B is represented by Wmax(B). This classification method is performed such that the rule of Wmin(A)>Wmax(B) is true. That is, the widths of all the pitch regions of the group A are greater than the widths of all the pitch regions of the group B.

When the plurality of pitch regions are classified into a group A, a group B, and a group C, which are three pitch region groups, the following rules are applied.

Wmin(A)>Wmax(B)

Wmin(B)>Wmax(C)

Here, Wmax(C) is a maximum value of the widths of the pitch regions falling within the group C.

In addition, when the plurality of pitch regions are classified into a group A, a group B, a group C, and a group D, which are four pitch region groups, the following rules are applied.

Wmin(A)>Wmax(B)

Wmin(B)>Wmax(C)

Wmin(C)>Wmax(D)

Here, Wmin(C) is a minimum value of the widths of the pitch regions falling within the group C, and Wmax(D) is a maximum value of the widths of the pitch regions falling within the group D.

That is, the pitch regions are grouped and ranked according to the width of each thereof. For example, when the four groups (that is, the group A, the group B, the group C, and the group D) are enumerated in descending order of width, the result is given as the group A, the group B, the group C, and the group D in the stated order.

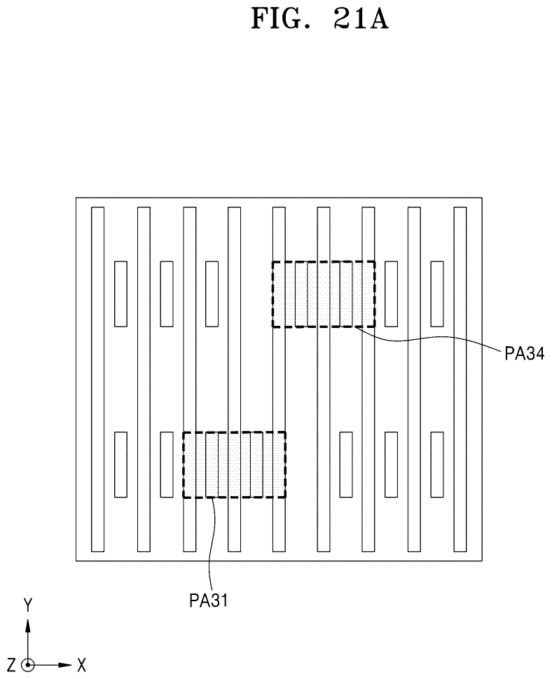

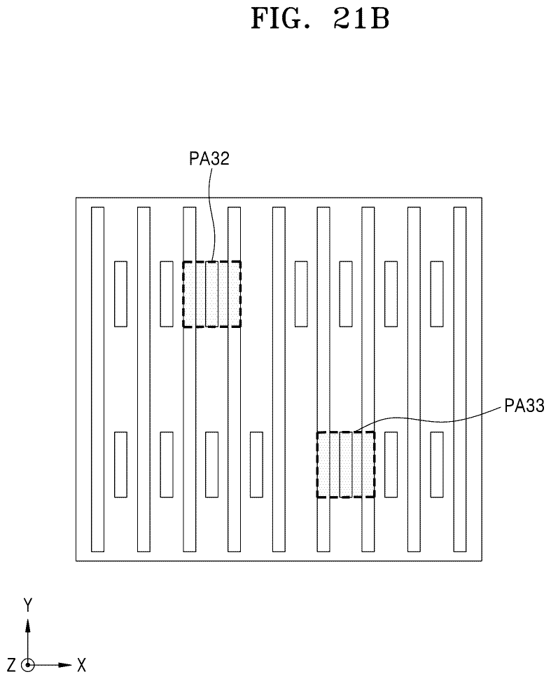

Because the first to fourth pitch regions PA31, PA32, PA33, and PA34 in the layout shown in FIG. 20 have only two kinds of pitch region widths, the first to fourth pitch regions PA31, PA32, PA33, and PA34 in the layout shown in FIG. 20 may be classified into the first pitch region group (which may be referred to as a pitch region group A) including the first and fourth pitch regions PA31 and PA34 shown in FIG. 21A and the second pitch region group (which may be referred to as a pitch region group B) including the second and third pitch regions PA32 and PA33 shown in FIG. 21B. When the pitch region group A shown in FIG. 21A and the pitch region group B shown in FIG. 21B are enumerated in descending order of width, the result is given as the pitch region group A and the pitch region group B in the stated order.

In process P40B of FIG. 19, the classified pitch region groups are sequentially processed one-by-one such that each pitch region group is selected from the classified pitch region groups and then processed. Here, according to descending order of width, the pitch region group A having a maximum width is selected first.

N=1 is set in process P40C, and then, a pitch enlargement process is performed to sequentially perform process P40D, process P40E, and process P40F in the stated order only on patterns of the pitch region group A. The pitch enlargement process including process P40D, process P40E, and process P40F is substantially similar to the pitch enlargement process (the jog-generation avoidance process) described with reference to FIG. 14. However, in the present process, an obstacle hindering the movement of a pattern is removed by using a process of splitting patterns. The process of splitting patterns as such is described below in detail.

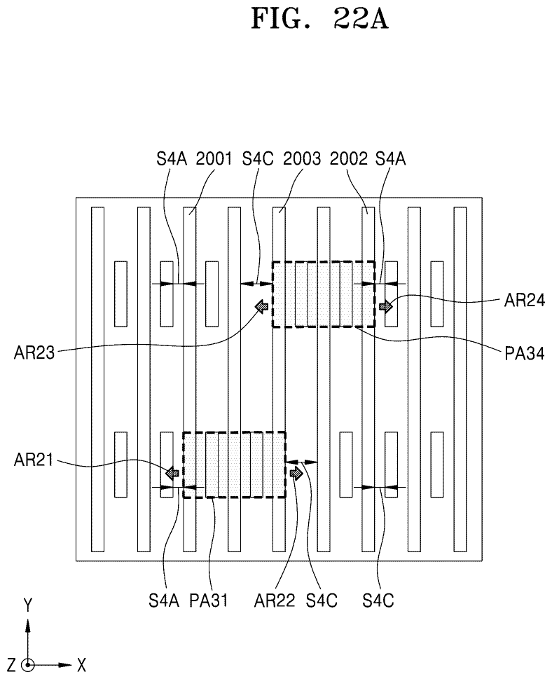

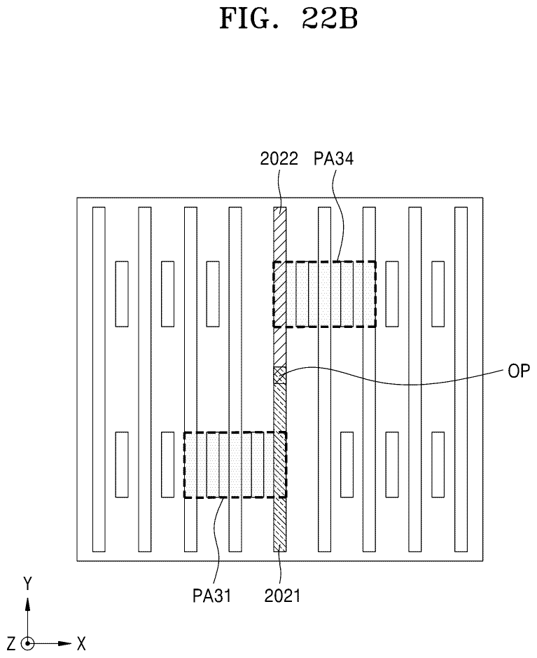

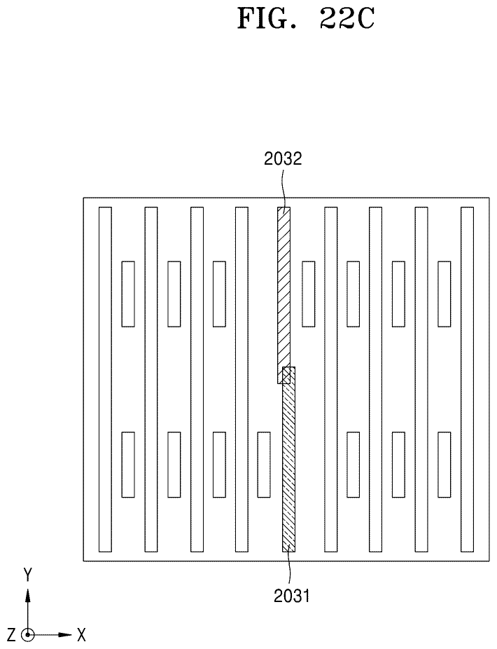

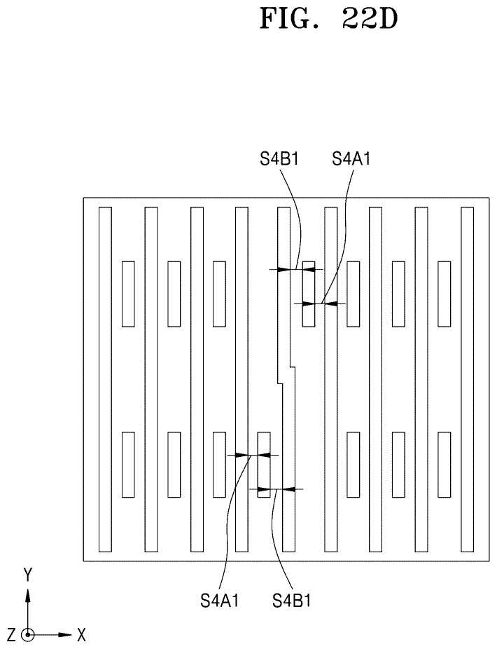

FIGS. 22A, 22B, 22C, and 22D are examples of layouts for describing processes P40D, P40E, and P40F of FIG. 19 in detail.

In process P40D of FIG. 19, in the same manner as in process P30C of FIG. 14, a plurality of patterns 2001, 2002, and 2003 are selected from the layout shown in FIG. 22A. Around each of the plurality of patterns 2001, 2002, and 2003 selected from the layout shown in FIG. 22A, a space width S4A may be 17 nm and a space width S4C may be 52 nm.

In FIG. 22A, in pitch enlargement directions respectively indicated by arrows AR21 and AR24 from among arrows AR21, AR22, AR23, and AR24, there are no pitch enlargement spaces of patterns of the first and fourth pitch regions PA31 and PA34. Although there are sufficient pitch enlargement spaces in pitch enlargement directions respectively indicated by the arrows AR22 and AR23, the pattern 2003 of the fourth pitch region PA34 is shared by the second pitch region PA31 having a movement direction opposite to the direction indicated by the arrow AR23 and thus is not able to be moved. Herein, the pattern 2003 shared by the second pitch region PA31 and the fourth pitch region PA34 may be referred to as a shared pattern.

According to process P40E of FIG. 19, the pattern 2003, which is a shared pattern in the layout of FIG. 22A, may be split into two separate patterns 2021 and 2022, as shown in FIG. 22B. A position at which the pattern 2003 is split is between the second pitch region PA31 and the fourth pitch region PA34 sharing the pattern 2003.

As shown in FIG. 22B, the two separate patterns 2021 and 2022 obtained by splitting the pattern 2003 may each have an overlap region OP in which the two separate patterns 2021 and 2022 overlap each other. Because the position at which the pattern 2003 is split is between the second pitch region PA31 and the fourth pitch region PA34 sharing the pattern 2003, the overlap region OP may also be located between the second pitch region PA31 and the fourth pitch region PA34. When there is the overlap region OP, after pattern modification is performed in subsequent process P40F of FIG. 19, the distance between respective corners of patterns may not be too small.

In process P40F of FIG. 19, it is checked whether there are sufficient spaces for the split separate patterns 2021 and 2022 to be moved in the direction for pitch enlargement, followed by independently moving the split separate patterns 2021 and 2022 respectively in directions of the arrows AR22 and AR23, thereby obtaining patterns 2031 and 2032 shown in FIG. 22C. In the method of FIG. 19, an output layout of a first loop (N=1) of the pitch enlargement applied to the pitch region group A has increased space widths S4A1 and S4B1 between patterns, as shown in FIG. 22D. In FIG. 22D, the space width S4A1 may be 16 nm and the space width S4B1 may be 20 nm. As such, when the first loop (N=1) is completed in the method of FIG. 19, in process P40G of FIG. 19, it is checked whether a set number of iterations have been performed. When the set number of iterations are not satisfied in process P40G of FIGS. 19, 1 is added to the loop counter N in process P40H, and the method of FIG. 19 returns to process P40D and repeats the same process. When it is determined in process P40I of FIG. 19 that there is a pitch region remaining not processed, the method of FIG. 19 returns to process P40B and repeats the same process.

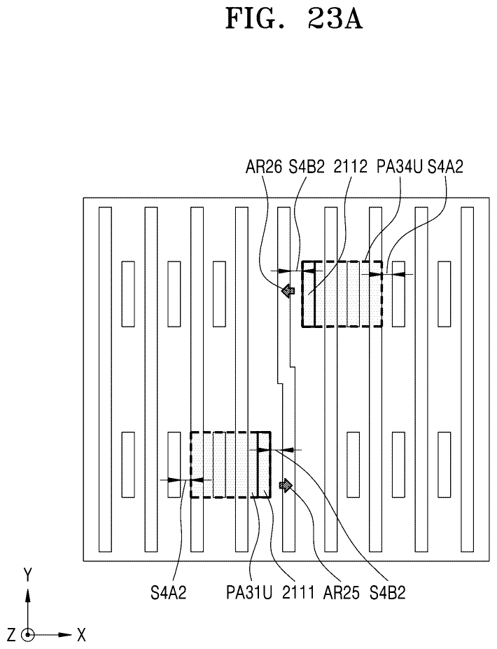

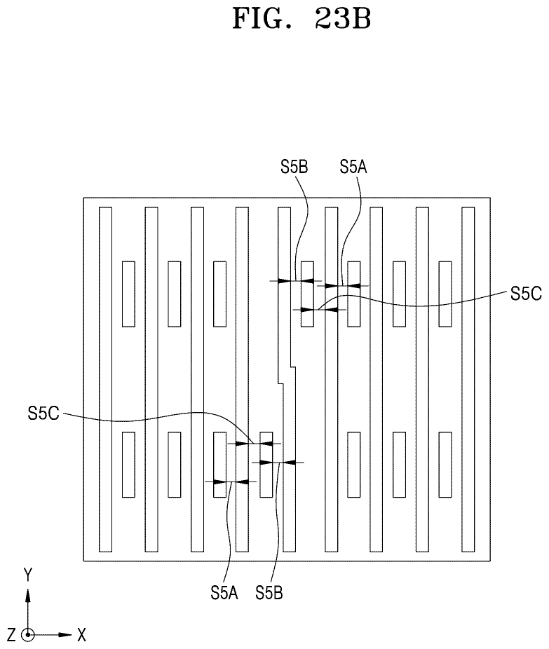

Next, a second loop (N=2) in the method of FIG. 19 is briefly described with reference to FIGS. 23A and 23B. In process P40D of FIG. 19, before patterns are selected, pitch regions of the pitch region group A may be updated by using the output layout of the first loop (N=1), thereby setting updated first and fourth pitch regions PA31U and PA34U. FIG. 23A illustrates newly selected patterns 2111 and 2112 together with the updated first and fourth pitch regions PA31U and PA34U. In this case, because there is no pattern required to be split as in process P40E of FIG. 19, the method of FIG. 19 proceeds to process P40F, thereby independently moving the patterns 2111 and 2112 respectively in directions of arrows AR25 and AR26. Here, in process P40F, as described regarding process P30D of FIG. 14, all the patterns selected are shifted for pitch enlargement. In FIG. 23A, around the updated first and fourth pitch regions PA31U and PA34U, a space width S4A2 may be 17 nm and a space width S4B2 may be 20 nm.

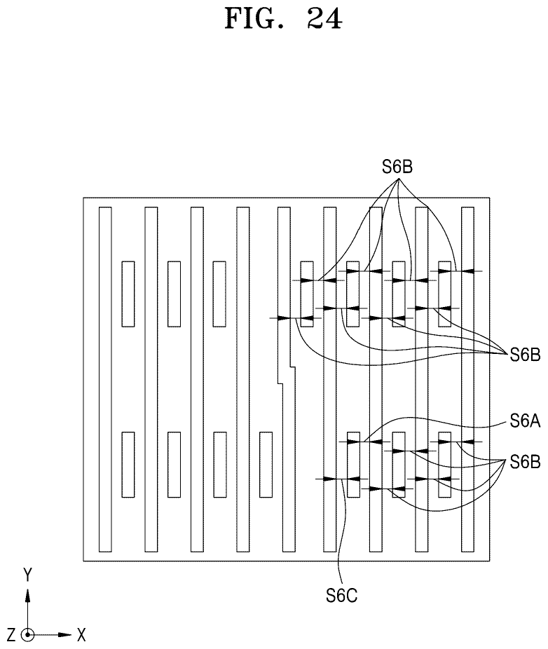

A layout obtained as a result of performing the second loop (N=2) described above is shown in FIG. 23B. The layout of FIG. 23B has increased space widths S5A, S5B, and S5C between patterns. In FIG. 23B, the space width S5A may be 16 nm, the space width S5B may be 17 nm, and the space width S5C may be 19 nm. When process P40D, process P40E, and process P40F of FIG. 19 from among the processes described above are repeated, a final layout having increased space widths S6A, S6B, and S6C between patterns, as shown in FIG. 24, may be obtained as a final result in which the pitches of the patterns of the pitch region group A are increased. In the layout of FIG. 24, the space width S6A may be 16 nm, the space width S6B may be 17 nm, and the space width S6C may be 18 nm.

When the pitch enlargement process for the patterns of the pitch region group A is completed through the processes described above, the method of FIG. 19 may proceed to a process for patterns of the pitch region group B.

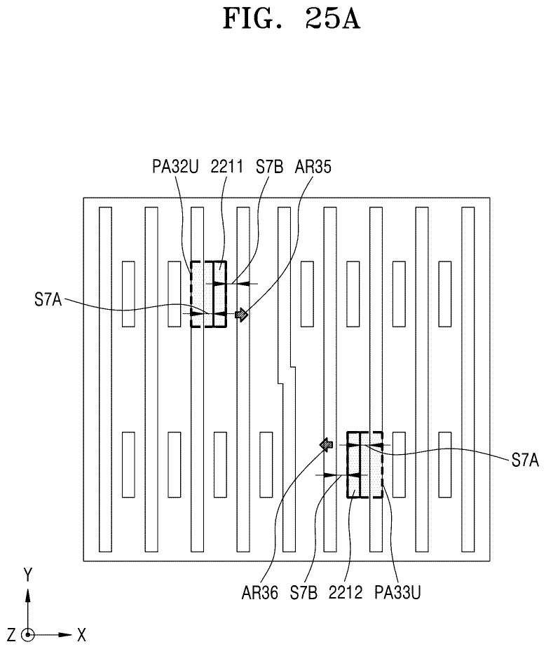

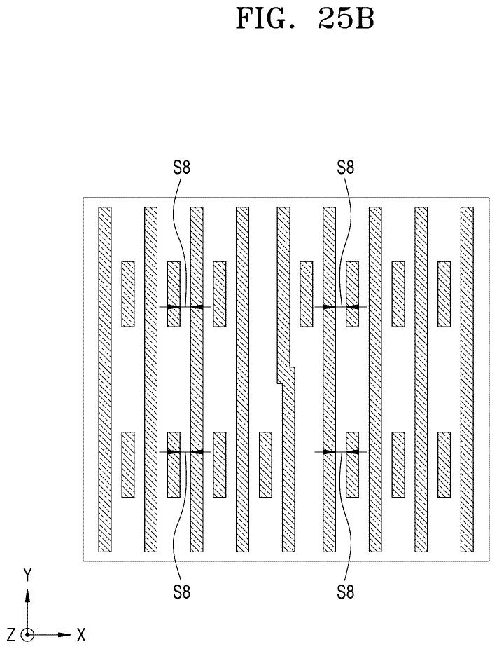

A pitch enlargement process applied to the pitch region group B is described by using a layout of FIG. 25A. The layout of FIG. 25A shows a result in which updated second and third pitch regions PA32U and PA33U are selected from pitch regions of the pitch region group B in the layout modified as shown in FIG. 24 by the pitch enlargement in the pitch region group A.

In the layout of FIG. 25A, after the updated second and third pitch regions PA32U and PA33U are set, patterns 2211 and 2212 may be newly selected from the updated second and third pitch regions PA32U and PA33U, and the newly selected patterns 2211 and 2212 may be independently moved respectively in directions of arrows AR35 and AR36 through the same pitch enlargement process as the pitch enlargement process having been applied to the pitch region group A, thereby obtaining a final layout shown in FIG. 25B. In FIG. 25A, around the newly selected patterns 2211 and 2212, a space width S7A may be 16 nm and a space width S7B may be 18 nm. In the layout shown in FIG. 25B, a space width S8 between patterns may be 17 nm.

As described above, when a plurality of pitch enlargement processes are simultaneously applied to one pattern, jogs are generated. When one pattern intersects several pitch regions, a plurality of pitch enlargement processes may be performed on the one pattern. Therefore, by grouping pitch regions and processing the grouped pitch regions one-by-one, performing a plurality of pitch enlargement processes on one pattern may be reduced, and thus, the generation of jogs may also be reduced. In the methods according to embodiments, which are described above, the reason for processing pitch regions in descending order according to the sizes of the pitch regions is for applying, by priority, a pitch enlargement process to a pitch region including more patterns.

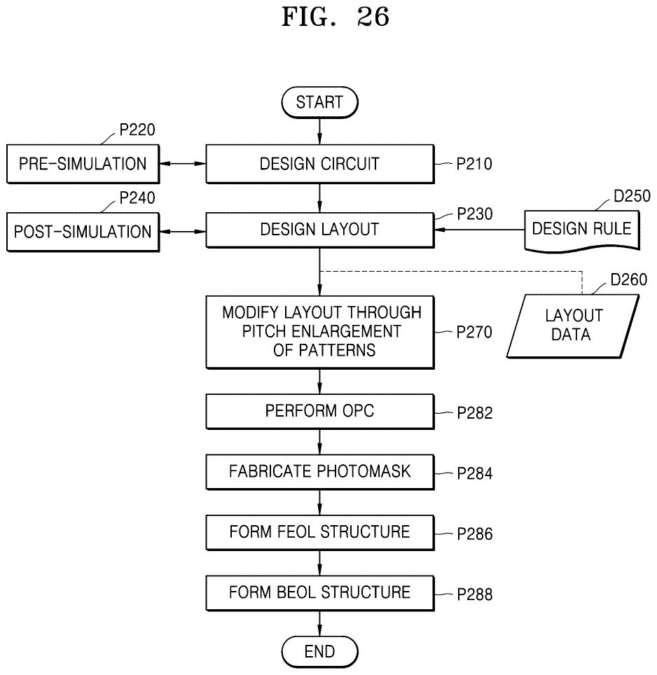

FIG. 26 is a flowchart illustrating a method of manufacturing an integrated circuit device, according to some embodiments.

Referring to FIG. 26, in process P210, circuit design may be performed. For example, various devices (for example, a transistor and the like) may be designed to satisfy the performance of an integrated circuit device intended to be formed. In some embodiments, the circuit design may be performed by a circuit design tool that provides a user interface to a designer.

The circuit design according to process P210 may be performed by referring to a result of a pre-simulation performed in process P220. For example, the pre-simulation may be performed to test the performance of a designed circuit, and a structure of the circuit may be modified according to the result of the pre-simulation.

In process P230, layout design may be performed. In some embodiments, the layout design may be performed by a layout design tool.

The layout design according to process P230 may be performed by referring to a result of a post-simulation performed in process P240. A layout designed in process P230 may be modified according to the result of the post-simulation.

The layout design according to process P230 may be performed based on a design rule D250. The design rule D250 may define a plurality of rules based on a process of manufacturing the integrated circuit device. For example, the design rule D250 may define a pitch of patterns, a space between patterns, and the like, which are allowed in the same conductive layer. The layout of the integrated circuit device may be designed to comply with the plurality of rules defined by the design rule D250.

When the layout design is completed in process P230, layout data D260 defining the layout may be generated. The layout data D260 may include geometric information of patterns that are included in the integrated circuit device intended to be formed.

In process P270, layout modification may be performed through pitch enlargement of the patterns of the layout. To perform process P270, a layout modification process according to the 2-step process described with reference to FIG. 19 may be performed.

In process P282, OPC may be performed. The OPC may collectively refer to operations of forming a pattern with an intended shape by correcting a distortion phenomenon, such as refraction due to characteristics of light in a photolithography process performed during the process of manufacturing the integrated circuit device.

By applying the OPC to the layout modified in process P270, a pattern on a photomask to be fabricated in process P284 subsequent to the OPC may be determined. In some embodiments, the layout of the integrated circuit device may be restrictively modified in the process of performing the OPC according to process P282.

In process P284, a photomask may be fabricated. For example, because the layout data D260 undergoes the layout modification through the pitch enlargement of the patterns in the layout as in process P270 and then undergoes the application of the OPC, stochastic defects may be suppressed in patterns that are on a photomask and necessary to form a plurality of patterns. In process P284, at least one photomask for forming patterns, which are to be implemented on a substrate, of each of a plurality of layers may be fabricated.

In process P286, a front-end-of-line (FEOL) process for manufacturing the integrated circuit device may be performed, thereby forming an FEOL structure on the substrate.

In the process of forming the FEOL structure, individual devices may be formed on the substrate. The individual devices may include, but are not limited to, a transistor, a capacitor, a resistor, and the like. The FEOL process may include a photolithography process, a planarization process of structures, a cleaning process, an etching process, a deposition process, an ion implantation process, a conductive film forming process, an insulating film forming process, and the like, for forming the FEOL structure.

In process P288, a back-end-of-line (BEOL) process may be performed on a resulting product in which the FEOL structure is formed, thereby forming a BEOL structure.

The BEOL process may include processes of electrically connecting, to each other, the individual devices of the FEOL structure formed in process P286. The BEOL process may include a photolithography process, a process of forming a plurality of conductive films, a process of forming a plurality of conductive via contacts, a process of forming a plurality of interconnection layers, a silicidation process, a plating process, an insulating film deposition process, a passivation film forming process, and the like, for forming the BEOL structure. A resulting product obtained by performing the BEOL process according to process P288 may be packaged and used as a component of various applications.

At least one process out of the process of forming the FEOL structure according to process P286 of FIG. 26 and the process of forming the BEOL structure according to process P288 of FIG. 26 may be performed by using the photomask fabricated in process P284 of FIG. 26.

Next, effects of the inventive concept, which were confirmed from results of applying a method according to embodiments to an actual LSI layout, are described.

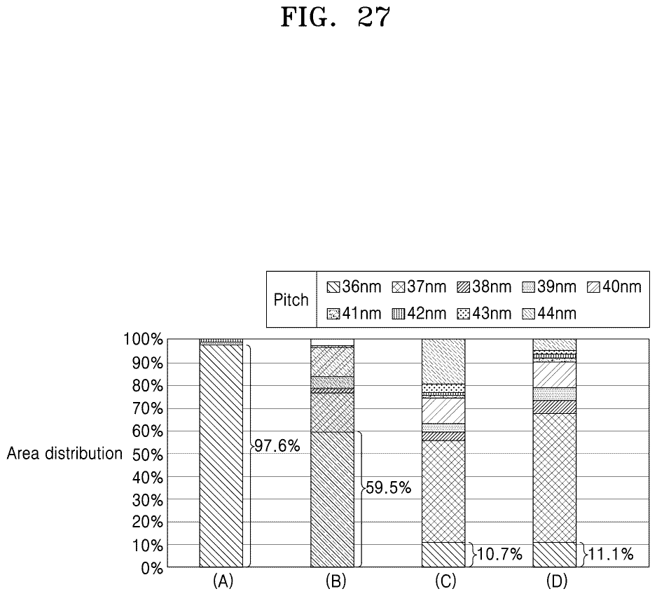

FIG. 27 is a graph obtained by evaluating area distributions of patterns having pitches less than 45 nm in layouts each including a plurality of patterns arranged at various pitches. In FIG. 27, (A) represents an area distribution of patterns having pitches less than 45 nm in an input pattern layout not having undergone a pitch enlargement process, (B) represents an area distribution of patterns having pitches less than 45 nm in a layout having undergone a pitch enlargement process by using the jog-generation avoidance process described with reference to FIG. 14, (C) represents an area distribution of patterns having pitches less than 45 nm in a layout having undergone a pitch enlargement process by using the simple pitch enlargement process described with reference to FIG. 9, and (D) represents an area distribution of patterns having pitches less than 45 nm in a layout having undergone a pitch enlargement process according to the 2-step process described with reference to FIG. 19.

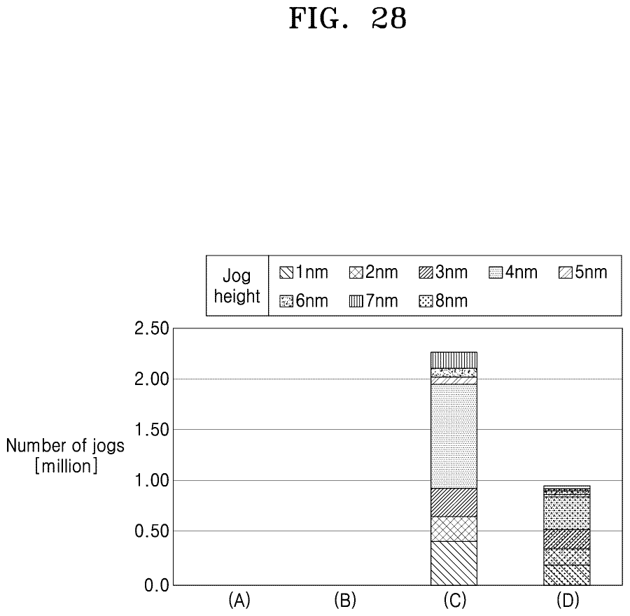

FIG. 28 is a graph illustrating results (that is, the number of jogs) of evaluating how many jogs there are in each of the layouts used in the evaluation of FIG. 27. Because there is no jog in the input LSI layout, the number of jogs measured in the present evaluation indicates the number of jogs generated during the performance of each of the evaluated processes.

From the evaluation results of FIGS. 27 and 28, it was confirmed that, in (B) corresponding to the jog-generation avoidance process described with reference to FIG. 14, although there is no jog generated, there is a relatively low effect of pitch enlargement because about 60% of minimum pitches remain not enlarged. It was confirmed that, in both of (C) corresponding to the simple pitch enlargement process described with reference to FIG. 9 and (D) corresponding to the pitch enlargement process described with reference to FIG. 19, effects of pitch enlargement are similar to each other and the area of minimum pitch regions may be reduced to a level of about 10% of the original area of minimum pitch regions. The amount of jogs generated in (D) corresponding to the pitch enlargement process described with reference to FIG. 19 is less than 40% of the amount of jogs generated in (C) corresponding to the simple pitch enlargement process described with reference to FIG. 9. That is, it may be understood that the pitch enlargement process described with reference to FIG. 19 is effective in reducing the area of minimum pitch regions while minimizing the generation of jogs. Therefore, by modifying a layout according to a method of the inventive concept, stochastic defects may be extremely effectively solved in a patterning process using EUV photolithography.

In addition, when an interconnection structure including patterns arranged at a pitch of 36 nm was formed on a wafer by modifying a layout according to a method of the inventive concept and performing an EUV photolithography process, a defect density of 0.2 defects/cm² in the interconnection structure and a patterning yield of 65.2% were obtained, and it was confirmed that these are improved results as compared with a defect density of 0.3 defects/cm² and a patterning yield of 50.2% for a comparison sample not undergone the layout modification according to the inventive concept.

The methods described herein, including the methods described in connection with FIGS. 2, 9, 14, 19, and 26, may be performed by any type of electronic device configured to execute one or more processes, such as, for example, a computing device. Such a computing device may include one or more of the following components: at least one central processing unit (CPU) configured to execute computer program instructions to perform various processes and methods, random access memory (RAM) and read only memory (ROM) configured to access and store data and information and computer program instructions, I/O devices configured to provide input and/or output to the computing device (e.g., keyboard, mouse, display, etc.), and storage media or other suitable type of memory, where the files that comprise an operating system, application programs, and/or other applications, and data files are stored. The computing device may be configured to perform the operations described herein, which such operations implemented in hardware, software, firmware, or any combination thereof. If implemented in software, the functions can be stored as one or more instructions or code on computer-readable medium, including the computer-readable medium described above (e.g., RAM, ROM, storage media, etc.). In example embodiments, the design rule D250 and layout data D260 may be stored in the read only memory (ROM) and may be loaded into the random access memory (RAM) and/or read only memory (ROM), and may be used by the at least one central processing unit (CPU) in connection with the methods disclosed herein.

The above-described methods may be used to manufacture semiconductor devices including logic devices and memory devices, and further processes may be performed on a semiconductor substrate including an integrated circuit device to form the semiconductor devices. For example, additional conductive and insulating layers may be deposited on the semiconductor substrate to form a plurality of semiconductor chips, and the semiconductor chips may then be singulated, packaged on a package substrate, and encapsulated by an encapsulant to form a semiconductor package. The semiconductor devices may include, for example, finFET, DRAM, VNAND, etc. The semiconductor devices may be applied in various systems, such as computing systems.

While the inventive concept has been particularly shown and described with reference to embodiments thereof, it will be understood that various changes in form and details may be made therein without departing from the spirit and scope of the following claims.

What is claimed is:

1. A layout modification method comprising:
extracting a plurality of first pitch regions each including a plurality of first patterns from a layout of a target to be modified;
through at least one loop process, performing a first modification to generate a first modified layout by shifting a position of at least one first pattern selected from the plurality of first patterns of each of the plurality of first pitch regions;
after the first modification is performed, extracting a plurality of second pitch regions each including a plurality of second patterns from the first modified layout;
classifying the plurality of second pitch regions into a plurality of pitch region groups according to widths of the plurality of second patterns in a pitch direction of the plurality of second patterns; and
performing a second modification to generate a second modified layout by shifting a position of at least one second pattern selected from the plurality of second patterns of each of the plurality of second pitch regions, in descending order starting from a pitch region group having a maximum width in the pitch direction of the plurality of second patterns from among the plurality of pitch region groups.

2. The layout modification method of claim 1,
wherein, in the first modification, the shifting of the position of the at least one first pattern comprises shifting all portions of the at least one first pattern in a first direction or in a second direction opposite to the first direction, the first direction being identical to a pitch direction of the plurality of first patterns, and
wherein in the second modification, the shifting of the position of the at least one second pattern comprises shifting all portions of the at least one second pattern in the first direction or in the second direction.

3. The layout modification method of claim 1,
wherein, in the first modification, the shifting of the position of the at least one first pattern comprises moving the at least one first pattern by as much as a distance according to an equation shown below:
Movement distance=EPS×(number of iterations+1−N),
wherein, in the equation shown above,
EPS is a pitch enlargement size to be applied to the plurality of first patterns,
the number of iterations is defined by MAPS/EPS, where MAPS is a maximum allowable pattern shift size, and
N is a loop counter of the at least one loop process in the first modification.

4. The layout modification method of claim 1,
wherein, in the second modification, the shifting of the position of the at least one second pattern comprises moving the at least one second pattern by as much as a distance according to an equation shown below:
Movement distance=EPS×(number of iterations+1−N),
wherein, in the equation shown above,
EPS is a pitch enlargement size to be applied to the plurality of second patterns,
the number of iterations is defined by MAPS/EPS, where MAPS is a maximum allowable pattern shift size, and
N is a loop counter of the at least one loop process in the first modification.

5. The layout modification method of claim 1,
wherein, in the second modification, the plurality of second pitch regions comprise two second pitch regions falling within a same pitch region group from among the plurality of pitch region groups,
wherein the plurality of second patterns comprise one shared pattern that is shared by the two second pitch regions, and
wherein the second modification comprises:
before the shifting of the position of the selected at least one second pattern, splitting the shared pattern into two separate patterns; and
independently moving respective positions of the two separate patterns.

6. The layout modification method of claim 5, wherein the two separate patterns each have an overlap region in which the two separate patterns overlap each other.

7. The layout modification method of claim 5, wherein, in the splitting of the shared pattern into the two separate patterns, the shared pattern is split at a point in the shared pattern between the two second pitch regions.

8. The layout modification method of claim 5,
wherein the two separate patterns each have an overlap region in which the two separate patterns overlap each other, and
wherein the overlap region is located between the two second pitch regions.

9. The layout modification method of claim 5, wherein, in the independently moving of the respective positions of the two separate patterns, one of the two separate patterns is moved in a first direction that is identical to the pitch direction of the plurality of second patterns, and the other one of the two separate patterns is moved in a second direction that is opposite to the first direction.

10. The layout modification method of claim 1,
wherein, in each of the plurality of first pitch regions, a space between each of the plurality of first patterns has a first width in a first direction that is identical to a pitch direction of the plurality of first patterns,
wherein before the second modification is performed, in each of the plurality of second pitch regions, some of spaces between each of the plurality of second patterns each have a second width in the first direction, the second width being greater than the first width, and the others of the spaces between each of the plurality of second patterns each have the first width in the first direction, and
wherein after the second modification is performed, all the spaces between each of the plurality of second patterns each have a third width that is greater than the first width.

11. The layout modification method of claim 1,
wherein the plurality of first patterns respectively have inconsistent lengths in a second horizontal direction perpendicular to a first direction that is identical to a pitch direction of the plurality of first patterns, and
wherein a length of each of the plurality of first pitch regions in the second horizontal direction is equal to a length of a first pattern, which has a minimum length in the second horizontal direction, among the plurality of first patterns.

12. A layout modification method comprising:
extracting a plurality of first pitch regions each including a plurality of first patterns from a layout of a target to be modified;
performing a first modification to generate a first modified layout in which positions of some of the plurality of first patterns are shifted such that space widths between each of the plurality of first patterns are not constant in a pitch direction of the plurality of first patterns, by shifting a position of at least one first pattern selected from the plurality of first patterns in each of the plurality of first pitch regions;
after the first modification is performed, extracting a plurality of second pitch regions each including a plurality of second patterns from the first modified layout;
classifying the plurality of second pitch regions into a plurality of pitch region groups according to widths of the plurality of second patterns in a pitch direction of the plurality of second patterns; and
performing a second modification to generate a second modified layout by shifting a position of at least one second pattern selected from the plurality of second patterns of each of the plurality of second pitch regions, in descending order starting from a pitch region group having a maximum width in the pitch direction of the plurality of second patterns from among the plurality of pitch region groups,
wherein, after the second modification is performed, all space widths between each of the plurality of second patterns are greater in the pitch direction of the plurality of second patterns than the space widths between each of the plurality of first patterns.

13. The layout modification method of claim 12,
wherein, in the first modification, the shifting of the position of the at least one first pattern comprises shifting all portions of the at least one first pattern in a first direction or in a second direction opposite to the first direction, the first direction being identical to the pitch direction of the plurality of first patterns, and
wherein in the second modification, the shifting of the position of the at least one second pattern comprises shifting all portions of the at least one second pattern in the first direction or in the second direction.

14. The layout modification method of claim 12,
wherein each of the first modification and the second modification is performed through at least one loop process,
wherein the shifting of the position of the at least one first pattern in the first modification and the shifting of the position of the at least one second pattern in the second modification comprise moving the at least one first pattern by as much as a distance according to an equation shown below and moving the at least one second pattern by as much as a distance according to the equation shown below, respectively,
Movement distance=EPS×(number of iterations+1−N)
wherein, in the above equation,
EPS is a pitch enlargement size to be applied to the plurality of first patterns or the plurality of second patterns,
the number of iterations is defined by MAPS/EPS, where MAPS is a maximum allowable pattern shift size, and
N is a loop counter of the at least one loop process in each of the first modification and the second modification.

15. The layout modification method of claim 12,
wherein. in the second modification, the plurality of second pitch regions comprise two second pitch regions falling within a same pitch region group from among the plurality of pitch region groups,
wherein the plurality of second patterns comprise one shared pattern that is shared by the two second pitch regions, and
wherein the second modification comprises:
before the shifting of the position of the selected at least one second pattern, splitting the shared pattern into two separate patterns; and
independently moving respective positions of the two separate patterns.

16. The layout modification method of claim 15,
wherein the two separate patterns each have an overlap region in which the two separate patterns overlap each other, and
wherein the overlap region is located between the two second pitch regions.

17. The layout modification method of claim 15, wherein, in the splitting of the shared pattern into the two separate patterns, the shared pattern is split at a point in the shared pattern between the two second pitch regions.

18. The layout modification method of claim 15, wherein, in the independently moving of the respective positions of the two separate patterns, one of the two separate patterns is moved in a first direction that is identical to the pitch direction of the plurality of second patterns, and the other one of the two separate patterns is moved in a second direction that is opposite to the first direction.

19. A method of manufacturing an integrated circuit device, the method comprising:
designing a layout;
extracting a plurality of first pitch regions each including a plurality of first patterns from the layout;
through at least one loop process, performing a first modification to generate a first modified layout by shifting a position of at least one first pattern selected from the plurality of first patterns of each of the plurality of first pitch regions;
after the first modification is performed, extracting a plurality of second pitch regions each including a plurality of second patterns from the first modified layout;
classifying the plurality of second pitch regions into a plurality of pitch region groups according to widths of the plurality of second patterns in a pitch direction of the plurality of second patterns;
performing a second modification to generate a second modified layout by shifting a position of at least one second pattern selected from the plurality of second patterns of each of the plurality of second pitch regions, in descending order starting from a pitch region group having a maximum width in the pitch direction of the plurality of second patterns from among the plurality of pitch region groups;
performing optical proximity correction (OPC) on the second modified layout;
fabricating a photomask by using a resulting product obtained by performing the OPC on the second modified layout; and
forming a plurality of interconnection lines on a substrate by using the photomask.

20. The method of claim 19,
wherein, in the first modification, the shifting of the position of the at least one first pattern comprises shifting all portions of the at least one first pattern in a first direction or in a second direction opposite to the first direction, the first direction being identical to a pitch direction of the plurality of first patterns, and
wherein in the second modification, the shifting of the position of the at least one second pattern comprises shifting all portions of the at least one second pattern in the first direction or in the second direction.
